(19) United States
(12) Patent Application Publication
(10) Pub. No.: US 2009/0037470 A1
(43) Pub. Date: Feb. 5, 2009

(54) CONNECTING USERS BASED ON MEDICAL EXPERIENCES

(76) Inventor: Joseph Otto Schmidt, Los Angeles, CA (US)

Correspondence Address: BOSWELL INTELLECTUAL PROPERTY LAW PLLC, PO BOX 1950, SEATTLE, WA, 98111, US

(21) Appl. No.: 12/060,802

(22) Filed: Apr. 1, 2008

Related U.S. Application Data
(60) Provisional application No. 60/962,542, filed on Jul. 30, 2007.

(51) Int. Cl. G06F 17/00

(52) U.S. Cl. 707/104.1

(57) ABSTRACT

A medical interaction system is described that promotes connections of a medical nature between individuals, patients, doctors, nurses, therapists, and others. Users can share personal information with other users. Owners of personal information have complete control over what they share and with whom they share it by using built in access controls. The system provides search features so users can find other users who have common medical experiences, such as diagnosis, medication, health care provider, and therapist. Thus, the medical information system provides an environment for users to share medical experiences and connect with others in a way that reduces social isolation, increases experiential knowledge, and inspires confidence that others have successfully dealt with similar problems before.

### CROSS-REFERENCE TO RELATED APPLICATIONS

This application claims the benefit of U.S. Provisional Application No. 60/962,542 (Attorney Docket No. 66185-8001.US00) entitled “GenerationMed Backbone,” and filed on Jul. 30, 2007, which is hereby incorporated by reference.

### BACKGROUND

A social network service uses software to build online social networks for communities of people who share interests and activities or who are interested in exploring the interests and activities of others. Most social network services are web based and provide a collection of various ways for users to interact, such as chat, messaging, email, video, voice chat, file sharing, blogging, discussion groups, and so on. The main types of social networking services are those which contain directories of some categories (such as former classmates), means to connect with friends (usually with self-description pages), and recommender systems linked to trust. Popular methods now combine many of these, with MySpace and Facebook being the most widely used.

In general, social networking services allow users to create a profile for themselves, and can be broken down into two broad categories: internal social networking (ISN) and external social networking (ESN) sites. Both types can increase the feeling of community among people. An ISN is a closed/private community that consists of a group of people within a company, association, society, education provider, and organization, or even an “invite only” group created by a user in an ESN. An ESN is open/public and available to all web users to communicate, such as MySpace, Facebook, and Bebo, and is generally designed to attract advertisers. Users can upload a picture of themselves and can often be “friends” with other users.

Another type of online service is a medical information site, such as WebMD. WebMD is a medical and wellness information service, primarily known for its public internet site, which provides health information, a symptom checklist, pharmacy information, and a place to store personal medical information. The site is reported to receive over 40 million hits each month and is the leading health portal in the United States according to comScore Media Metrix.

Neither of these types of online services effectively addresses the human side of medicine. Social networking sites allow only demographic connections such as through searching for people of a similar age, gender, location, and so forth. Such sites do not allow deeper connections based on experiences. Medical information sites often contain volumes of academic medical data, but lack the application of that information to individual people. Having a medical condition can be an isolating and fear-inducing experience. The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram that provides an overview of the environment in which the system operates in one embodiment.

FIG. 2 is a block diagram that illustrates the components of the medical interaction system in one embodiment.

FIG. 3 is a block diagram that illustrates the types of information that the medical interaction system stores in a user's profile in one embodiment.

FIG. 4 is a flow diagram that illustrates the steps performed by the profile management component of the medical interaction system to create a new user profile in one embodiment.

FIG. 5 is a unified modeling language (UML) diagram that illustrates the functionality of the diagnosis management component in one embodiment.

FIG. 6 is a flow diagram that illustrates the processing of the diagnosis management component to associate a diagnosis with a user profile in one embodiment.

FIG. 7 is a display diagram that illustrates a display page for editing diagnoses associated with a user profile in one embodiment.

FIG. 8 is a display diagram that illustrates a display page for editing entities associated with a diagnosis in one embodiment.

FIG. 9 is a flow diagram that illustrates the processing of the profile management component to add a new entity to a user profile in one embodiment.

FIG. 10 is a display diagram that illustrates a display page containing a daybook in one embodiment.

FIG. 11 is a flow diagram that illustrates the processing of the profile management component to add a daybook entry in one embodiment.

FIG. 12 is a display diagram that illustrates a display page containing a gradebook in one embodiment.

FIG. 13 is a flow diagram that illustrates the processing of the profile management component to add a gradebook entry in one embodiment.

FIG. 14 is a data structure diagram that illustrates the type of data that the medical interaction system stores in the profile store in one embodiment.

FIG. 15 is a data structure diagram that illustrates the associations between diagnosis data and user profiles stored by the medical interaction system in one embodiment.

FIG. 16 is a UML diagram that illustrates the functionality of the search component in one embodiment.

FIG. 17 is a block diagram that illustrates two users and the types of connections provided by the system through searching in one embodiment.

FIG. 18 is a display diagram that illustrates a display page for conducting a search through the medical interaction system in one embodiment.

FIG. 19 is a display diagram that illustrates an entity details panel displayed after a search in one embodiment.

FIG. 20 is a flow diagram that illustrates the processing of the search component of the medical interaction system to identify users based on medical experiences in one embodiment.

FIG. 21 is a flow diagram that illustrates the processing of the search component of the medical interaction system to conduct a search by user in one embodiment.

FIG. 22 is a UML diagram that illustrates the functionality of the blog component in one embodiment.

FIG. 23 is a display diagram that illustrates a display page for working with blog entries in one embodiment.

FIG. 24 is a data structure diagram that illustrates the data stored by the blog component in one embodiment.

FIG. 25 is a display diagram that illustrates a display page for controlling access to user information in one embodiment.

FIG. 26 is a flow diagram that illustrates the processing performed by the access control component to edit profile permissions in one embodiment.

FIG. 27 is a display diagram that illustrates a display page for viewing members of a profile owner's MedWeb in one embodiment.

FIG. 28 is a flow diagram that illustrates the processing of the profile management component to modify members of a profile owner's access tiers in one embodiment.

FIG. 29 is a data structure diagram that illustrates the data stored by the medical interaction system for a profile owner's access tiers in one embodiment.

FIG. 30 is a block diagram that illustrates two information hierarchies that the system displays to different user classes in one embodiment.

### DETAILED DESCRIPTION

### Overview

A medical interaction system is described that promotes connections of a medical nature between individuals, patients, doctors, nurses, therapists, and others. The system is accessible through a web-based, client-server application in which users share a common background of a medical nature. Users can share personal information with other users. Owners of personal information have complete control over what they share and with whom they share it by using built in access controls. Users can also hide their personal identity by using a mask profile. This allows them to participate in the community without fear of disclosing their real identity and opening themselves up to scrutiny in their everyday lives. Users can participate in the community by proxy using a guardian profile. A guardian profile is created for an individual in the care of a user and is separate from the user's own profile. The medical interaction system provides search features so users can find other users who have common medical experiences, such as diagnosis, medication, health care provider, and therapist. Thus, the medical information system provides an environment for users to share medical experiences and connect with others in a way that reduces social isolation, increases experiential knowledge, and inspires confidence that others have successfully dealt with similar medical conditions before.

The following sections describe: one embodiment of a suitable system for implementing the medical interaction system, diagnosis-based profiles, medical-based connections, verifying user identity and credentials, ratings of medical entities, and tiered access control for protecting information privacy.

### Suitable System

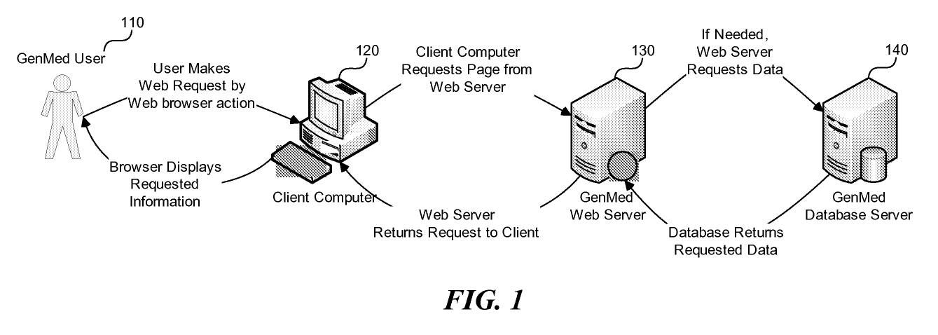

FIG. 1 is a block diagram that provides an overview of the environment in which the system operates in one embodiment. The medical interaction system is a web-based client-server application. Data and code for the application are stored in centrally located servers. A user 110 uses a client computer 120 to issue one or more web requests through a web browser (e.g., Microsoft Internet Explorer or Mozilla Firefox). The client computer 120 communicates with a web server 130 and database server 140 that host the medical interaction system. Those of ordinary skill in the art will recognize that the web server 130 and database server 140 may be hosted by multiple servers and that additional components (e.g., firewalls, routers, and so forth) that are not shown may be used to provide additional benefits. When a user makes a request to the system through the web server 130, the web server 130 determines if data stored in the database is available to respond to the request. If database data is available, the web server 130 request the data from the database server 140, and the database server 140 returns the data to the web server 130. The web server 130 transforms the data into a user-friendly format provides the formatted data to the client computer 120. The client computer 120 presents the data to the user.

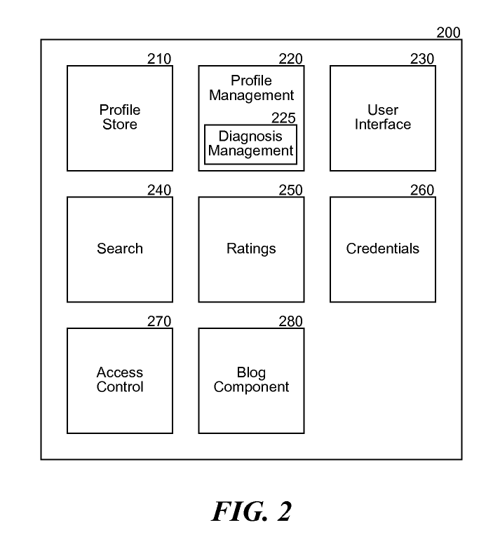

FIG. 2 is a block diagram that illustrates the components of the medical interaction system in one embodiment. The medical interaction system 200 contains a profile store 210, profile management component 220, user interface component 230, search component 240, ratings component 250, credentials component 260, access control component 270, and blog component 280. The profile store 210 stores information about each user. For example, the profile store may contain a user's screen name, one or more medical diagnoses of the user, the time the user last accessed the system, other users with which the user is associated, and so forth. The profile management component 220 manages adding and removing information about a user from the profile store 210. The profile management component 220 also includes a diagnosis management component 225 for associating diagnoses with a user. Many types of information in a user's profile are associated with a specific diagnosis managed by the diagnosis management component 225. The user interface component 230 provides a user interface for accessing the medical interaction system 200. For example, the user interface component 230 may provide one or more web pages for accessing information stored by the system 200 and for making connections with other users. The search component 240 allows a user to find other similar users based on a variety of search criteria. For example, a user may be able to find users that received a similar medical diagnosis, visited a similar hospital, used a similar insurance provider, was prescribed a similar medication, and so forth.

The ratings component 250 provides ratings information about various medical entities. For example, the ratings component 250 may receive user ratings about treatments, doctors, hospitals, medications, and other medical entities that correspond to the effectiveness of those entities. The ratings component 250 may provide these ratings to other users, such as based on a search result or browsing. The credentials component 260 verifies and provides assurance about a particular user's medical or other credentials. For example, if a user represents his or herself as a Registered Nurse, the credentials component 260 may verify that information with a state licensing board and may display a seal or other symbol alongside the user's screen name or profile that indicates the verified credentials held by the user. Other users can rely upon the displayed credentials to make judgments about the advice or experiences provided by that credentialed use. The access control component 270 controls access to a user's profile based on tiers controlled by the user. For example, the access control component 270 may define a core set of users that can view very private user information, a second tier of users that can view less private information, and so forth up to public information that anyone can view. The blog component 280 stores user blog entries and ratings associated with each blog entry. Each of these components is described in further detail in the sections below.

The computing device on which the system is implemented may include a central processing unit, memory, input devices (e.g., keyboard and pointing devices), output devices (e.g., display devices), and storage devices (e.g., disk drives). The memory and storage devices are computer-readable storage media that may be encoded with computer-executable instructions that implement the system, which means a computer-readable medium that contains the instructions. In addition, the data structures and message structures may be transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

The system may be implemented using various software paradigms and languages. For example, the system may use Asynchronous JavaScript and XML (AJAX) to enhance the user experience. AJAX improves user experiences with web-based applications by exchanging small amounts of data with the server “behind the scenes” so that the entire web page does not have to be reloaded each time the user performs an action. This increases the web page's interactivity, speed, functionality, and usability. The medical interaction system may use AJAX to present forms to the user for the collection of data, populate selection options, prepopulate text field entries as data is keyed into a form, provide user alerts and notifications, and for other appropriate interactions with the user.

In some embodiments, the medical interaction system uses JavaScript to perform actions on the client that would otherwise burden a server. The system may use JavaScript in conjunction with Dynamic Hypertext Markup Language (DHTML) functionality to enhance the user experience. For example, DHTML and JavaScript can be used to expand and collapse information panes described in further detail below.

### Diagnosis-Based Profile

The medical interaction system stores a profile for each user that tracks the user's screen name and basic facts (location, age, account settings, and so on) and serves as the gateway to other associations and activities. The owner of a user profile may generate personal content to introduce him/herself, or to inform, report, opinionate and share personal experience(s) on specific medical items, organizations, practitioners, procedures, diagnoses, and so forth. Once created, a user profile owner can generate two types of medical content: 1) diagnosis-independent content and 2) diagnosis-dependent content. Diagnosis-independent content is general information about the user that does not relate to a particular diagnosis. Diagnosis-dependent content is information related to a specific diagnosis, such as treatments, medications, and therapies experienced by the user.

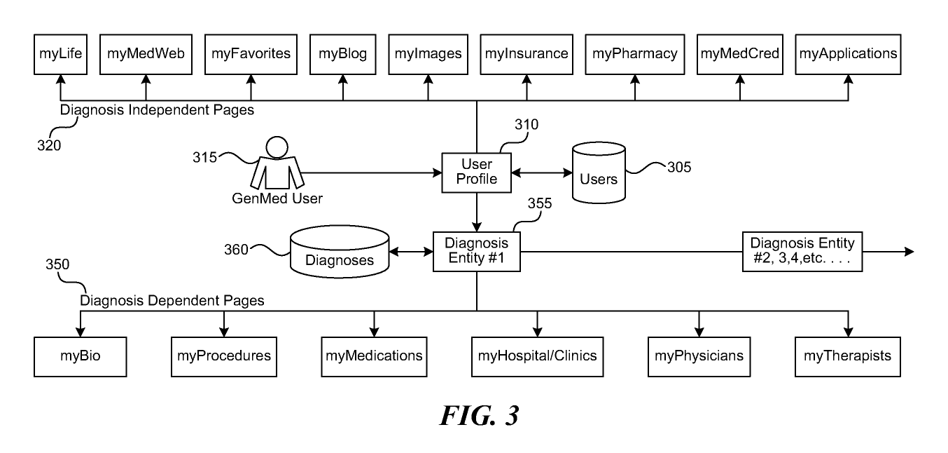

FIG. 3 is a block diagram that illustrates the types of information that the medical interaction system stores in a user's profile in one embodiment. A user database 305 stores one or more user profiles, such as user profile 310 associated with user 315. The user profile 310 contains information that is not associated with any particular diagnosis, called diagnosis-independent pages 320, and information that is associated with a specific diagnosis, called diagnosis-dependent pages 350. The diagnosis-dependent pages 350 are each associated with a specific diagnosis 355 stored in a diagnosis database 360. Each user profile 310 is associated with one or more diagnoses 355. The medical interaction system stores a list of medical diagnoses describing conditions experienced by the user in the user's profile. Users enter information about their diagnoses and the experiences they are going through. The system can maintain all aspects of the diagnosis, from the medication the user is taking to the health care providers who are treating the condition.

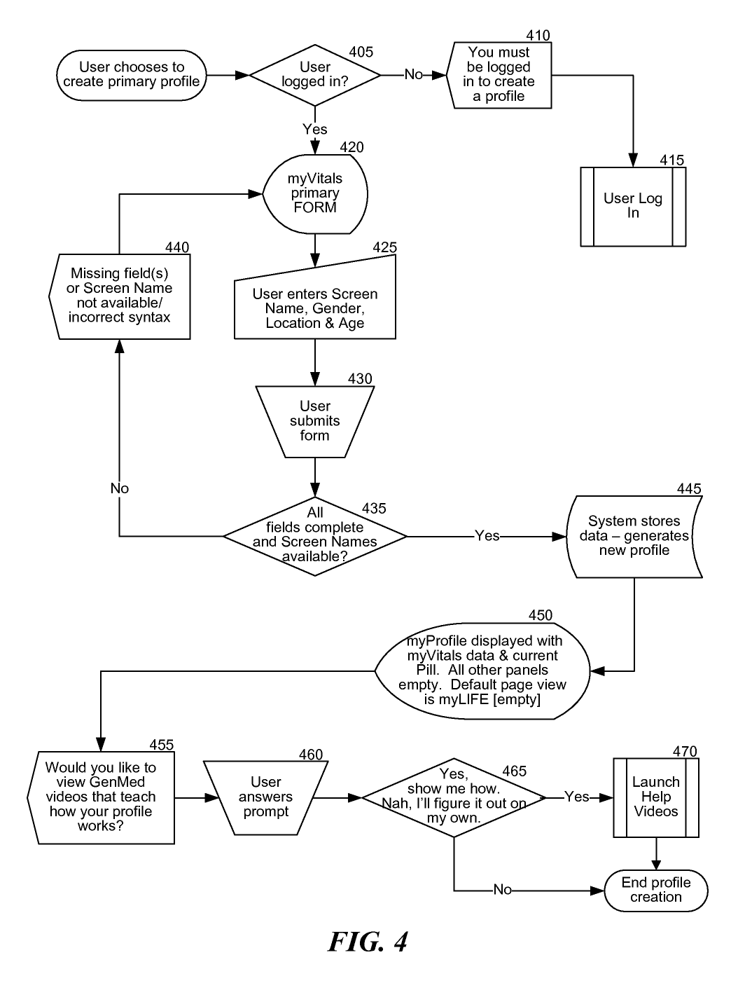

FIG. 4 is a flow diagram that illustrates the steps performed by the profile management component of the medical interaction system to create a new user profile in one embodiment. A user's interaction with the system starts with the creation of a user profile. In decision block 405, if the user is not logged in, then the component displays an error message in block 410 and in block 415 guides the user through logging in, else the component continues at block 420. In block 420, the component displays the primary form for receiving user information, called myVitals. In block 425, the component receives basic information about the user, such as a screen name, gender, location, and age. In block 430, the component receives an indication that the user submitted the displayed form and validates the received information. In decision block 435, if there is an error in the information submitted by the user, then the component displays an error in block 440 and loops to block 420 to display the form again, else the component continues at block 445.

In block 445, the component stores the received information in a new user profile in the profile store. In block 450, the component displays additional forms for receiving additional user information. In block 455, the component prompts the user to determine whether the user needs help adding additional profile information. In block 460, the component receives a response to the prompt from the user. In decision block 465, if the received response indicates that the user needs help, then the component continues at block 470 and displays helpful information, such as a video, to the user, else the component completes. After block 470, the component completes.

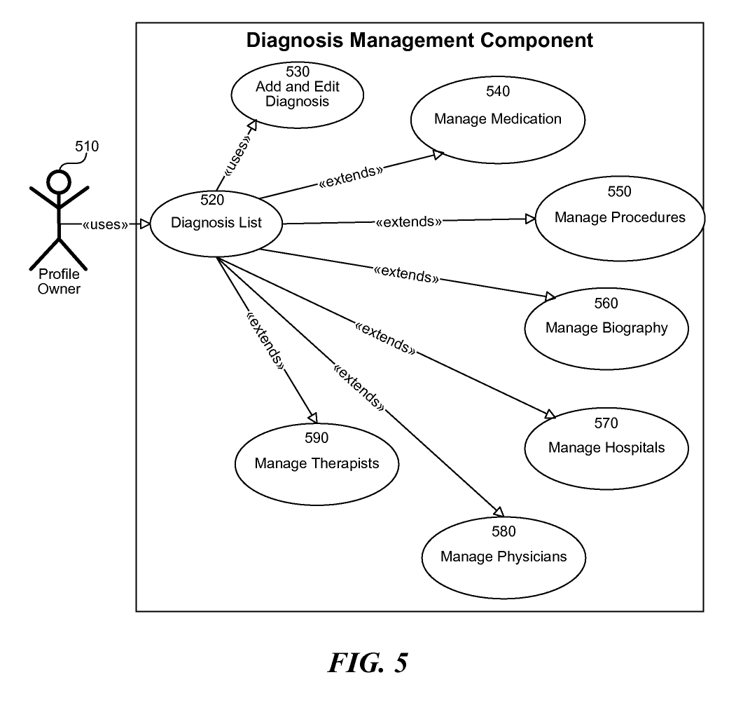

FIG. 5 is a unified modeling language (UML) diagram that illustrates the functionality of the diagnosis management component in one embodiment. A profile owner 510 uses a diagnosis list 520 to select diagnoses associated with the profile owner 510. The diagnosis management component provides a facility 530 for adding and editing diagnoses associated with the profile owner 510. The component also provides facilities for managing information associated with each diagnosis, including medications 540, procedures 550, a biography 560 describing the user's experiences, hospitals 570, physicians 580, and therapists 590.

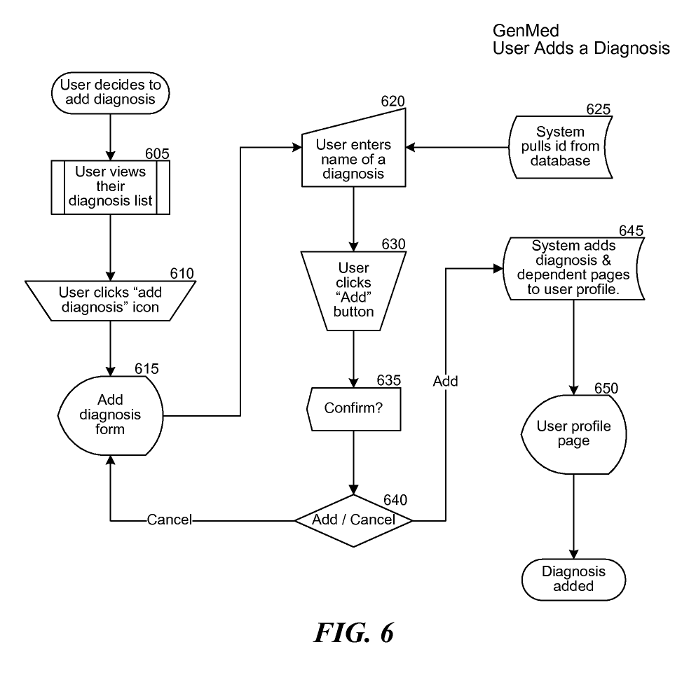

FIG. 6 is a flow diagram that illustrates the processing of the diagnosis management component to associate a diagnosis with a user profile in one embodiment. Once associated, the user can use the diagnosis to add information specific to that diagnosis and as a new way to connect to other users based on the diagnosis. In block 605, the component provides a list of existing diagnoses. In block 610, the component receives an indication that the user wants to add a new diagnosis. In block 615, the component displays an add diagnosis form to the user. In block 620, the component receives information identifying the diagnosis from the user. In block 625, the component optionally compares the diagnosis with a list of known diagnoses to determine a system identifier associated with the diagnosis. In block 630, the component receives an indication that the user wants to add the identified diagnosis to the user's profile. In block 635, the component displays a confirmation to the user. In decision block 640, if the component receives confirmation from the user, then the component continues at block 645, else the component loops to block 615. In block 645, the component adds the diagnosis and diagnosis-dependent pages related to the diagnosis to the user's profile. In block 650, the component displays the updated user profile including the new diagnosis and diagnosis-dependent pages. After block 650, the component completes.

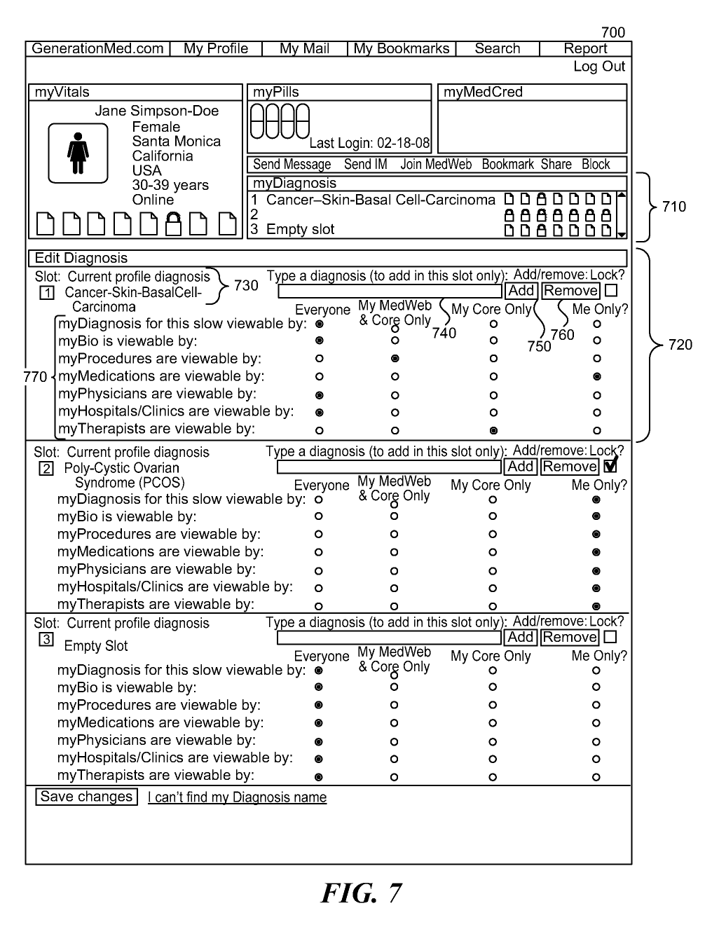

FIG. 7 is a display diagram that illustrates a display page for editing diagnoses associated with a user profile in one embodiment. The display page 700 contains a list 710 of diagnoses associated with the user profile, and one or more diagnosis editing areas 720. Each diagnosis editing area 720 contains a diagnosis name 730, a name entry box 740, an add button 750, a remove button 760, and a list of access controls 770. The diagnosis name 730 displays the name that currently identifies the diagnosis. The name entry box 740 receives information identifying a new diagnosis to add to the diagnosis editing area 720. The add button 750 receives an indication from a user to add the diagnosis specified by the name entry box 740 to the user's profile. The remove button 760 receives an indication from the user to remove the diagnosis identified by the diagnosis name 730 from the user's profile. The access controls 770 specify which users can view information associated with the diagnosis. Access controls are described in further detail below.

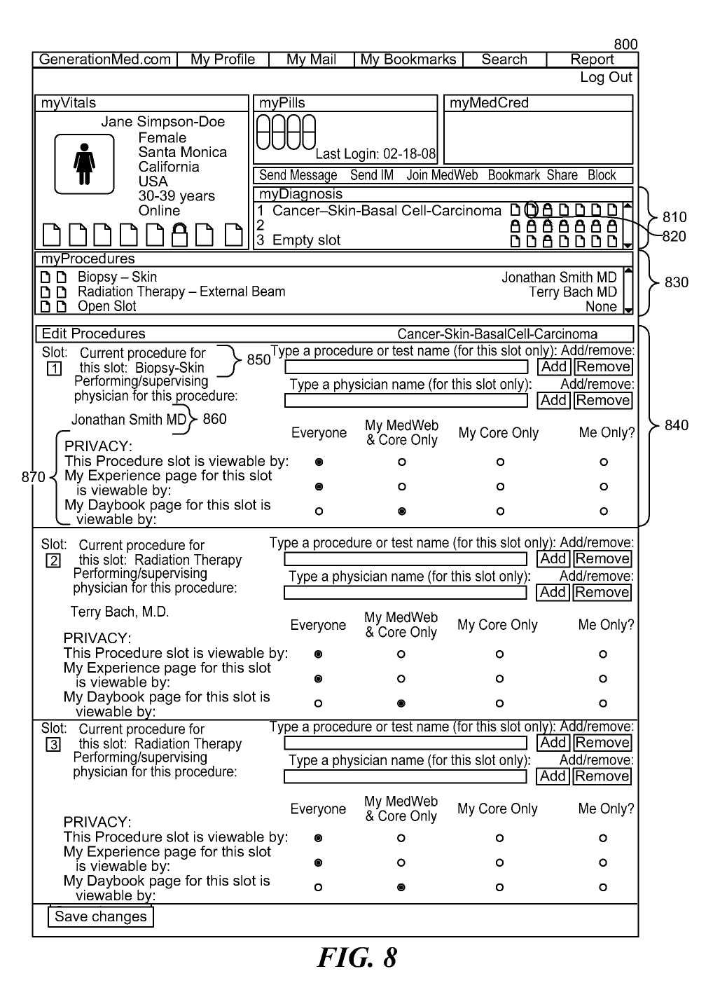

FIG. 8 is a display diagram that illustrates a display page for editing entities associated with a diagnosis in one embodiment. The display page 800 contains a diagnosis list 810, one or more detail icons 820, a list of entities 830 (e.g., procedures, therapies, hospitals, insurance providers, medications, and so on) associated with a selected diagnosis, and an entity editing area 840. The diagnosis list 810 lists the diagnoses currently associated with the user profile. The detail icons 820 indicate which diagnosis-dependent pages currently have information associated with them. For example, if the user has added information about procedures, then an icon associated with procedures is present in the details icons 820. This provides a quick visual indication of what information is present in the user's profile. The list of entities 830 lists the entities of a currently selected type (e.g., procedures as shown) that are associated with the selected diagnosis. The entity editing area 840 allows the user to add and remove entities from the user's profile. For example, for procedures, the entity editing area 840 provides an area for displaying and editing a procedure name 850, an area for displaying and editing a physician name 860 that performed the procedure, and access controls 870 for determining which users can view information about the procedure.

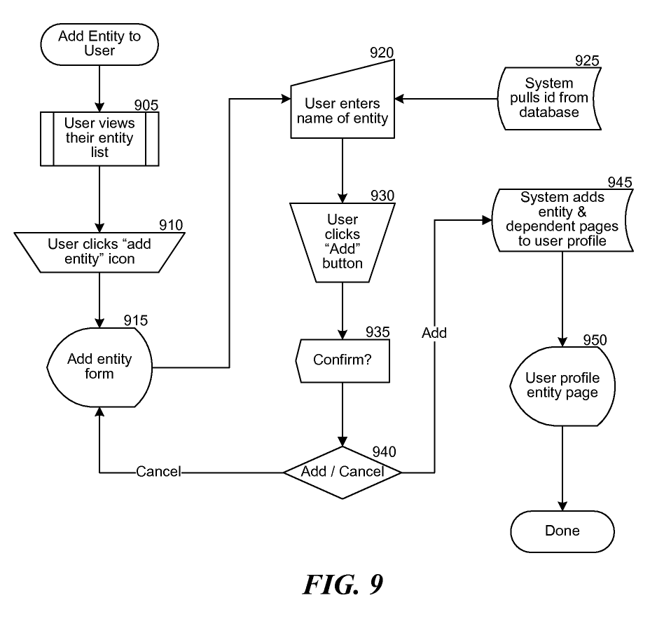

FIG. 9 is a flow diagram that illustrates the processing of the profile management component to add a new entity to a user profile in one embodiment. In block 905, the component provides a list of existing entities. For example, the component may list procedures that the user has undergone or hospitals that the user has visited. In block 910, the component receives an indication that the user wants to add a new entity. In block 915, the component displays an add entity form to the user. In block 920, the component receives information identifying the entity (e.g., a name or other associated information) from the user. In block 925, the component optionally compares the entity with a list of known entities to determine a system identifier associated with the entity. For example, if many users enter the same hospital, the system may store an identifier for that hospital to more easily identify similar information in different users' profiles. In block 930, the component receives an indication that the user wants to add the identified entity to the user's profile. In block 935, the component displays a confirmation to the user. In decision block 940, if the component receives confirmation from the user, then the component continues at block 945, else the component loops to block 915. In block 945, the component adds the entity and diagnosis-dependent pages related to the entity to the user's profile. In block 950, the component displays the updated user profile including the new entity and diagnosis-dependent pages. After block 950, the component completes.

In some embodiments, the medical interaction system displays user profile information in panels. A panel is a user interface element that contains textual or other types of information. For example, a panel may comprise a rectangular area of a web page that contains multiple such panels. A panel has a subject or title heading bar on top, and one or more text fields below for displaying data related to that subject or title. Some panels may contain buttons or icons to perform specific functions. Panels also allow the system to only display information for subjects for which the user has provided information. For example, the system may opt not to display a medications panel if the user has not entered any medications that the user has taken. Panels provide a unique, organized visual interface and can display many types of information, such as information to introduce him/herself, inform, report, opinionate, and share personal experience(s) on specific medical items, organizations, practitioner's, procedures, diagnoses, and or devices.

In some embodiments, users place content in daybooks, consisting of separate fields that are time-stamped by date and ordered chronologically. Daybooks typically focus on a specific entity (e.g., a doctor, medication, or treatment). Daybooks enable users to keep personal track of their interaction with any given entity. For example, a user could keep a daybook on Oxycodone to track his/her progress (or regress) with that medication. Other Oxycodone users will benefit from reading the user's Daybook on that medication (if the user decides to share it).

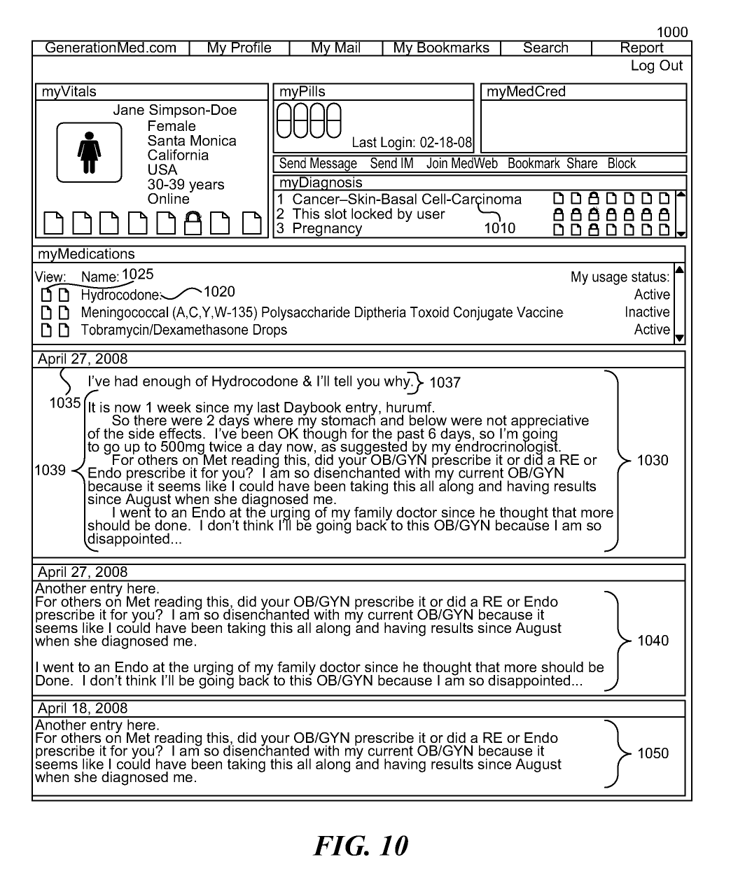

FIG. 10 is a display diagram that illustrates a display page containing a daybook in one embodiment. The display page 1000 contains a selected diagnosis 1010 and medication 1020 (or other entity) with which the daybook is associated. The icon 1025 indicates that a daybook is associated with the listed medication 1020 and when selected causes the system to display the daybook. The daybook contains a series of chronological entries 1030, 1040, and 1050 describing the user's experience with the medication (e.g., Hydrocodone). Each entry 1030 contains a date heading 1035, subject 1037, and text narrative 1039 that each provides details about the user's experience.

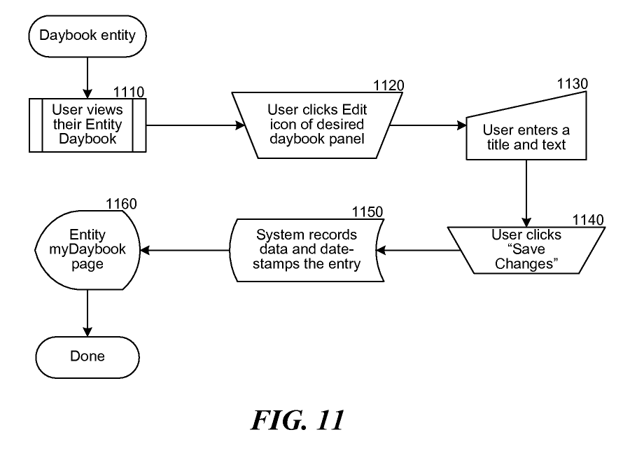

FIG. 11 is a flow diagram that illustrates the processing of the profile management component to add a daybook entry in one embodiment. In block 1110, the component receives a selection of a diagnosis and entity and displays a daybook associated with the selected diagnosis and entity. In block 1120, the component receives an indication that the user wants to edit the daybook. In block 1130, the component receives a subject and narrative from the user for the new daybook entry. In block 1140, the component receives an indication from the user that the user wants to save the changes to the new entry. In block 1150, the component stores the received subject and narrative along with a date associated with the entry (e.g., the current date and time). In block 1160, the component displays the updated daybook including the new entry to the user. After block 1160, the component completes.

In some embodiments, users place content in gradebooks, consisting of an assignable letter grade and a text field for data entry. Users can assign grades to fixed subject categories and elaborate on the categories with written user text in relation to the chosen entity. For example, if a user attaches the medication Oxycodone to their profile, they can grade and write about it across several categories in their gradebook. Other Oxycodone users can then benefit by reading this user's gradebook (report card) on Oxycodone. Additionally, for certain entities, gradebooks offer a rebuttal function that allows the entity that is the subject of the grading (e.g., a physician, representative of a hospital, and so on) to refute any grade or comments posted by the user, particularly if the user's view permissions permit the gradebook to be displayed to many or all users of the system. In some embodiments, the system provides an interface through which entities or representatives of entities can search for reviews about them and rebut any negative criticism.

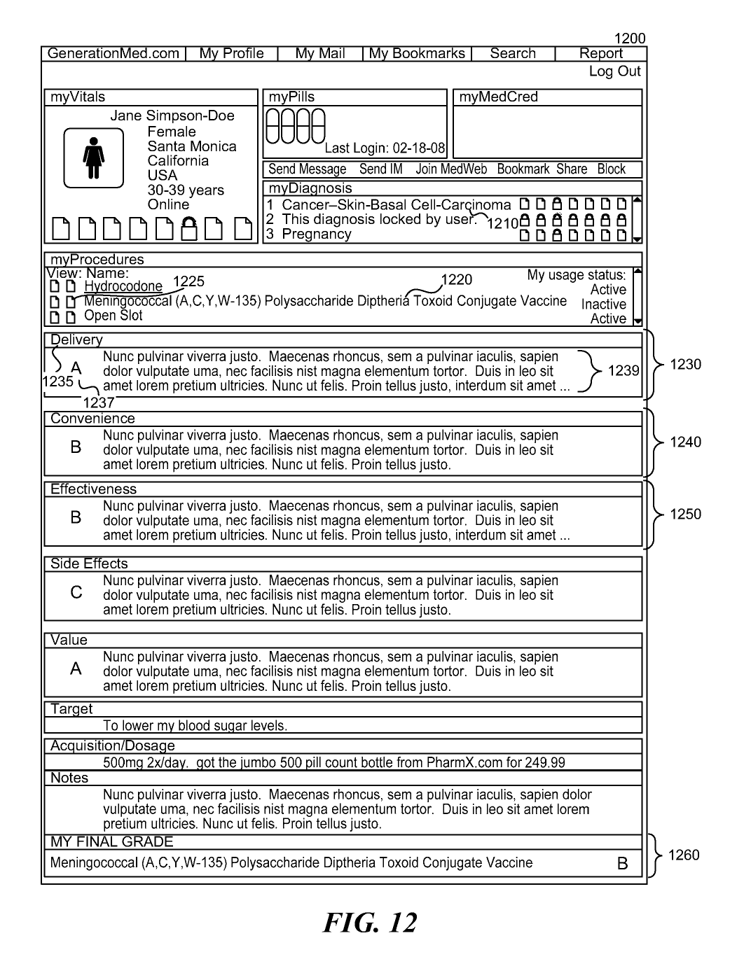

FIG. 12 is a display diagram that illustrates a display page containing a gradebook in one embodiment. The display page 1200 contains a selected diagnosis 1210 and medication 1220 (or other entity) with which the gradebook is associated. The icon 1225 indicates that a gradebook is associated with the listed medication 1220 and when selected causes the system to display the gradebook. The gradebook contains a series of category entries 1230, 1240, and 1250 describing the user's experience with the medication (e.g., Polysaccharide Diphtheria Toxoid Conjugate Vaccine). Each entry 1230 contains a category heading 1235, grade 1237, and text narrative 1239 that each provides details about the user's experience. The gradebook also contains a final grade 1260 determined by averaging the grades for each category entry. Although FIGS. 10 and 12 illustrate a daybook and gradebook respectively for a medication entity, the system displays similar screens and/or panels for many other types of medical entities, such as doctors, therapists, hospitals, insurance providers, and so forth. The features illustrated are indicative of the types of layout and controls provided for interacting with and describing medical entities provided by the system, and those of ordinary skill in the art will recognize the extension of these concepts to other types of entities.

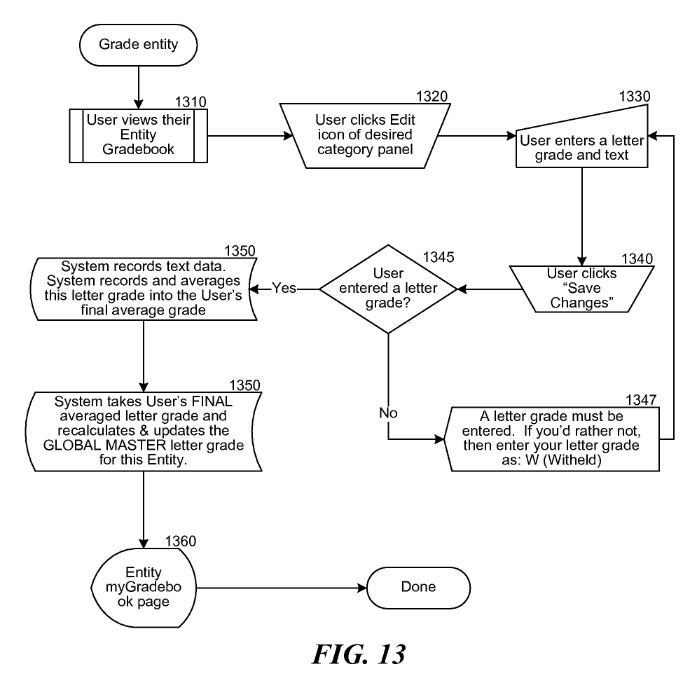

FIG. 13 is a flow diagram that illustrates the processing of the profile management component to add a gradebook entry in one embodiment. In block 1310, the component receives a selection of a diagnosis and entity and displays a gradebook associated with the selected diagnosis and entity. In block 1320, the component receives an indication that the user wants to edit the gradebook. In block 1330, the component receives a category, grade, and narrative from the user for the new gradebook entry. In block 1340, the component receives an indication from the user that the user wants to save the changes to the new entry. In decision block 1345, if the component received a valid letter grade, then the component continues at block 1350, else the component continues at block 1347 and prompts the user to enter a valid grade. After block 1347, the component loops to block 1330 to receive a valid grade. In block 1350, the component stores the received category, grade, and narrative with the entry and determines an average of each category in the gradebook. In block 1355, the component updates a global grade for the entity that spans users based on the user's new entry. In block 1360, the component displays the updated gradebook including the new entry to the user. After block 1360, the component completes.

In some embodiments, the medical interaction system stores special profiles for protecting a user's privacy or to provide additional benefits. For example, a guardian profile allows a user to create a profile for a person under the user's care that would not otherwise be able to use the medical interaction system (e.g., such as a child or due to an incapacitating illness). The user's profile may contain a list of guardian profiles associated with the user, and the user can generate content for the guardian profiles just as the user generates content for his/her own profile. Another type of special profile is a mask profile. A mask profile allows a user to hide his/her real identity, such as to avoid unwanted criticism for an embarrassing illness. A mask profile allows a user to be completely anonymous while still participating in the community provided by the medical interaction system. Another type of special profile is a legend profile. A legend profile identifies a user that has successfully overcome a condition that other users might be fighting. An administrator may verify that the user has overcome the condition (e.g., through medical documentation) before designating the user's profile with the legend status. The medical interaction system may feature legend profiles, such as by placing them on prominent pages or ranking them high in search results to inspire other users with the same diagnosis.

In some embodiments, the medical interaction system receives additional types of content from third parties. The medical interaction system provides an Application Programming Interface (API) for third parties to extend the functionality of the system, such as by providing content for additional panels. For example, Jenny Craig may provide a weight loss calculator based on information in the user's profile that displays a set of goals for the user to manage his/her weight.

A user's profile described herein may contain numerous types of content, including the daybooks and gradebooks described herein. Other examples of the types of content stored in a user profile are blogs, guestbooks, electronic mail, and so forth. The following tables list additional types of content that the system may store in a user's profile. The content may be displayed in panels or via another user interface.

General Information:

| | |
|---|---|
| myVitals | This panel consists of basic user information, including screen name, gender, |
| | location, age bracket, and online status. Additionally, users can upload a MedTag |
| | here, which is an avatar or picture of themselves or anything else they wish to |
| | represent themselves with. |
| myPills | This panel contains Pill icons. For every month that a user actively logs on to the |
| | network, they will receive that month's designated Pill. Over time, Pills displayed |
| | accumulate and identify how active a user is with the system. The myPills panel |
| | encourages more frequent log ins, as the more Pills a profile has, the more seniority |
| | and respect a user's profile will carry. Once twelve Pills are reached, the user |
| | receives a permanent silver Pillbox icon to represent one year of log ins. New Pills |
| | will again start accumulating until 12 are reached again, when another silver Pillbox |
| | is awarded, representing 2 years of log ins, and so on. |
| myMedCred | This panel is administration controlled and is used to display special or unique |
| | status icons awarded to users of the system. For example, any user who is officially |
| | certified in a medical field (such as a Physician, Registered Nurse, Paramedic, etc.) |
| | can submit credentials to the system operator. After confirming their credentials, |
| | the system operator designates the user's profile with a special status that |
| | designates the user's medical achievement(s). This status may be displayed |
| | through an icon. These MedCred icons may also be extended to users who |
| | deserve recognition, such as war veterans, rescue workers, firefighters, etc. |
| | Additionally, users may submit ID information for confirmation by the system. Once |
| | confirmed, the user receives an official MedCred icon “seal” that shows that the |
| | system has confirmed the user's ID information. MedCred icons are also |
| | searchable. Therefore, as an example, a user could search only for other users |
| | awarded war veteran icons on their profiles. Users may also submit their profiles |
| | for Legend consideration and, if approved, the unique Legend icon would appear |
| | here indicating that the user had overcome his/her diagnosis. |
| myDiagnosis | This panel lists any diagnosis that a user has attached to their profile. Users can |
| | add, edit, reorder, and move associated diagnoses based on personal preferences. |
| | Each diagnosis listed may have a row of icons, representing the diagnosis- |
| | dependent pages that will display if that diagnosis is selected. |
| Interaction Bar | The last component of a user profile is the Interaction Bar. This simple menu allows |
| | users to interact with each other from their profile displays. |

Diagnosis Independent Information:

| | |
|---|---|
| myLife | These panels allow users to share information about their personal lives. In |
| | addition, a Keywords panel allows users to enter any words they might have |
| | particular interest in (such as sky diving, cooking, Parakeets, etc.) that will become |
| | searchable terms to other users. |
| myMedWeb | These panels track users who have met over the network. An additional panel, |
| | called Guestbook, displays comments left by members of a User's MedWeb. |
| myFavorites | These panels allow a user to share information about their favorite medical |
| | products, media, and groups. |
| myBlog (and | These panels allow a user to maintain a blog, most likely related to their medical |
| Slogs) | experiences. Additionally, visiting users can leave comments and give each blog |
| | topic a “Jolt” (approval) or a “Tranq” (disapproval). Blogs can be ranked or |
| | searched based on their accumulated Jolts or Tranqs. A user may also designate |
| | any of his/her blog entries as a “Slog,” which is short for “Scathing Blog.” Slogs are |
| | an ideal rant vehicle for users wishing to get something off their chests, and set |
| | expectations for readers coming in that the content may be more emotional than |
| | substantive. |
| myImages | These panels allow users to display albums that contain any images they choose to |
| | upload. Images could be anything from family photos, to x-rays, to medical charts. |
| myInsurance | This panel allows a user to share their experience with a medical insurance |
| | provider. The first panel lists the provider the user is associated with. The next |
| | panels let the user Grade and comment on that provider's services (gradebook) and |
| | to keep a chronological log (daybook) of their interactions with that provider. |
| myPharmacy | This panel allows a user to share their experience with their pharmacy(-ies). The |
| | first panel lists the pharmacy the user frequents. The next panels let the user grade |
| | and comment on that pharmacy's services (gradebook). |
| myApplications | The system provides a platform for third-party development. The Applications panel |
| | contains controls for users to manage, use, and display their favorite third-party |
| | content. |

Diagnosis-Dependent Panels:

Diagnosis dependent panels are so named because users can attach more than one diagnosis to their profile. Consequently, data for these panels generally is associated with a specific diagnosis. For example, a user typically will not take the same medications for different diagnoses, nor would they have the same medical procedures for different diagnoses. Thus, each diagnosis-dependent panel references a particular diagnosis stored in the user's profile. After a user has associated a specific diagnosis with his/her profile, these panels become available for editing.

| | |
|---|---|
| myBio | These panels allow users to share information about their personal experience with |
| | this diagnosis. |
| myProcedures | These panels allow users to share a medical procedure they might undergo related |
| | to a certain diagnosis. The first panel lists the procedure type. The remaining |
| | panels let the user report on their experience and results before, during, and after |
| | the procedure. |
| myMedications | This panel allows users to share their experience with prescription, non- |
| | prescription, experimental, or alternative medications. The first panel lists the |
| | medication names the user has used. The next panels let the user Grade and |
| | comment on that medication's effectiveness (gradebook) and to keep a |
| | chronological log (daybook) of their interactions with that medication. |
| myPhysicians | This panel allows users to share their experience with a physician treating their |
| | diagnosis. The first panel lists the physician's name. The next panels allow a user |
| | to maintain a gradebook and daybook for their interactions with that physician. |
| myHospital/Clinics | This panel allows users to share their experience with any organization related to |
| | their treatment of a diagnosis. The first panel lists the organization's name. The |
| | next panels allow the user to maintain a gradebook and daybook for their |
| | interactions with that organization. |
| myTherapists | This panel allows users to share their experience with a therapist treating a |
| | diagnosis. The first panel lists the therapist's name. The next panels allow a user |
| | to maintain a gradebook and daybook for their interactions with that therapist. |

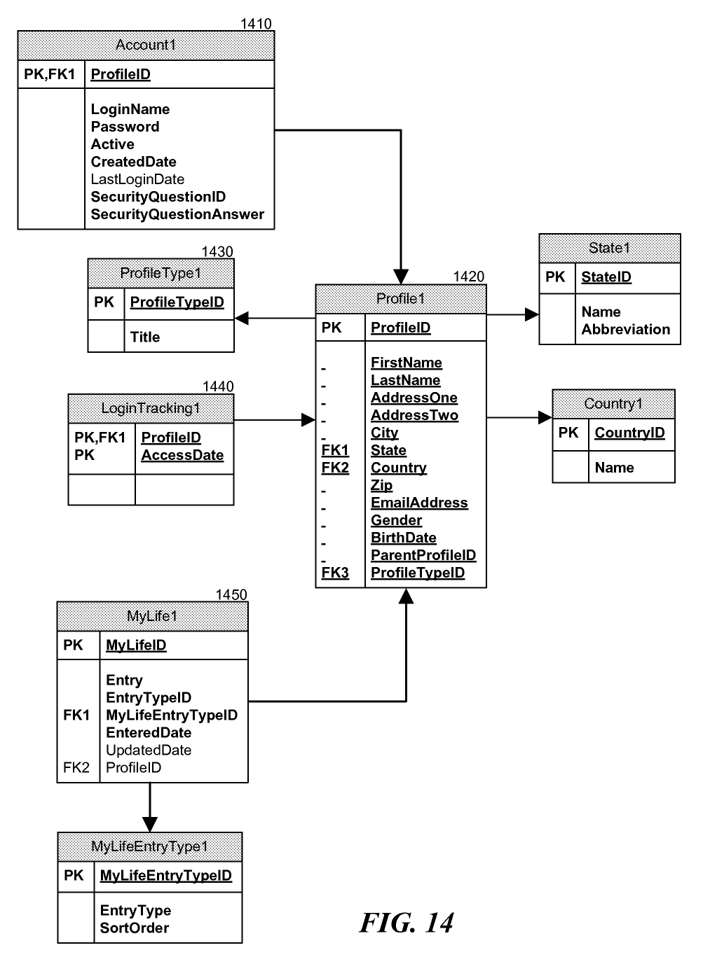

FIG. 14 is a data structure diagram that illustrates the type of data that the medical interaction system stores in the profile store in one embodiment. The system stores an account table 1410 that lists accounts of users known by the system. Each account in the account table 1410 is associated with one or more user profiles stored in a user profile table 1420. The user profile table is associated with other tables, such as a profile type table 1430 that stores the type of the profile (e.g., normal, mask, guardian, or legend) and a login tracking table 1440 that stores the time of each login by the user associated with the profile (e.g., for the myPills feature described herein). Each profile in the profile table 1420 may be associated with entries in one or more entity tables, such as entity table 1450.

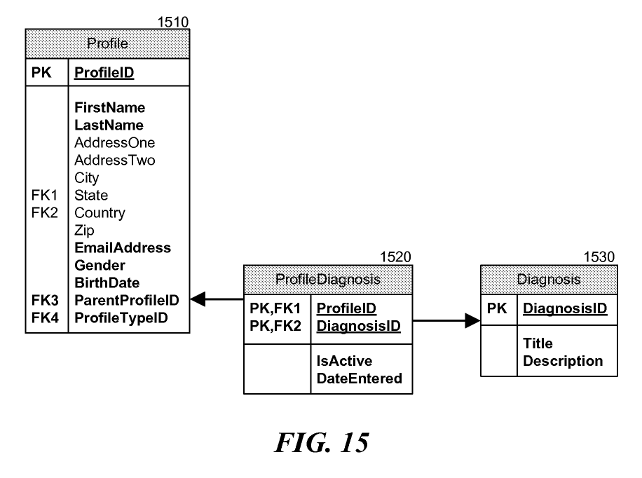

FIG. 15 is a data structure diagram that illustrates the associations between diagnosis data and user profiles stored by the medical interaction system in one embodiment. User profiles are stored in a profile table 1510 and diagnoses are stored in a diagnosis table 1530. A mapping table 1520 maps entries in the profile table 1510 to entries in the diagnosis table 1530. Many users may be associated with the same diagnosis and a single user may be associated with many diagnoses. The mapping table 1520 allows this type of many-to-many relationship.

### Medical-Based Connections

The medical interaction system encourages users to connect based on medical experiences using the diagnosis-based profile information described above. For example, users may search to find other users that have similar medical experiences based on diagnosis, medication, doctor, and so forth.

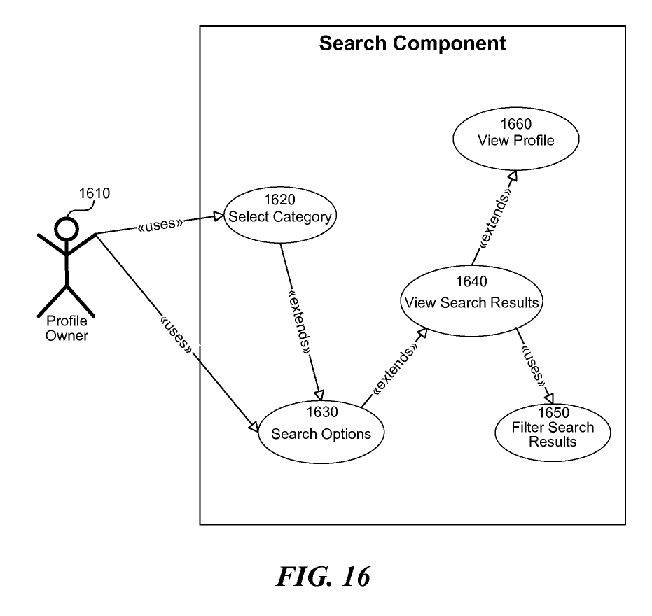

FIG. 16 is a UML diagram that illustrates the functionality of the search component in one embodiment. A profile owner 1610 selects a category 1620 and search options 1630 to identify search results 1640 based on medical experiences. The profile owner 1610 may specify filter criteria 1650 to narrow the search results. For example, the profile owner 1610 may only want to see users that live near the profile owner 1610. The profile owner 1610 can view profiles 1660 identified by the search results 1640.

In some embodiments, the medical interaction system maintains an entity page that collects information related to each entity stored by the system. An entity page is an .html or .asp page that represents any given entity in the system databases. The entity page consists of the entity's name, along with a set of controls to view specific information that is associated with that entity. The entity page collects information related to that entity in one place. When a user searches for a particular entity, the system may provide the user with a link each entity's entity page that is included in the search results. For example, if the user searches for Still's Disease, the system displays the Still's Disease entity page. From the Still's Disease entity page, the user could then view other users associated with this entity, an official description of Still's Disease, a list of specialists who treat Still's Disease, a list of procedures that remedy Still's Disease, and so on.

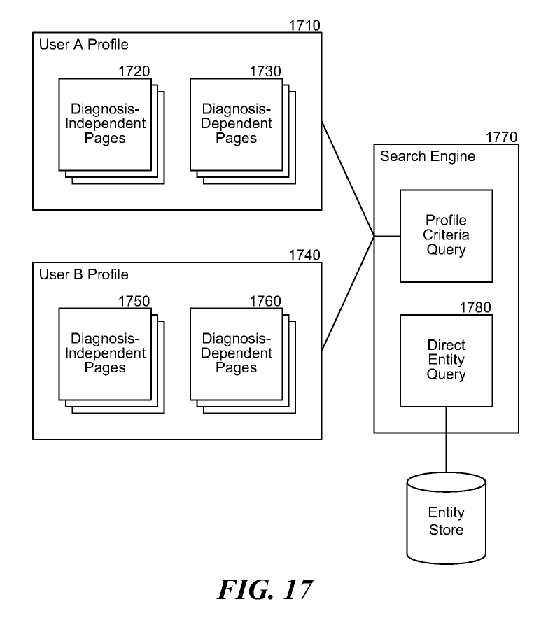

FIG. 17 is a block diagram that illustrates two users and the types of connections provided by the system through searching in one embodiment. User A's profile 1710 contains diagnosis-independent pages 1720 and diagnosis-dependent pages 1730. Similarly, User B's profile 1740 contains diagnosis-independent pages 1750 and diagnosis-dependent pages 1760. A search engine 1770 provided by the medical interaction system allows each user to query specific information in the other user's profile based on a variety of criteria. Alternatively, a user may directly enter 1780 a specific entity's name to find other users associated with that entity.

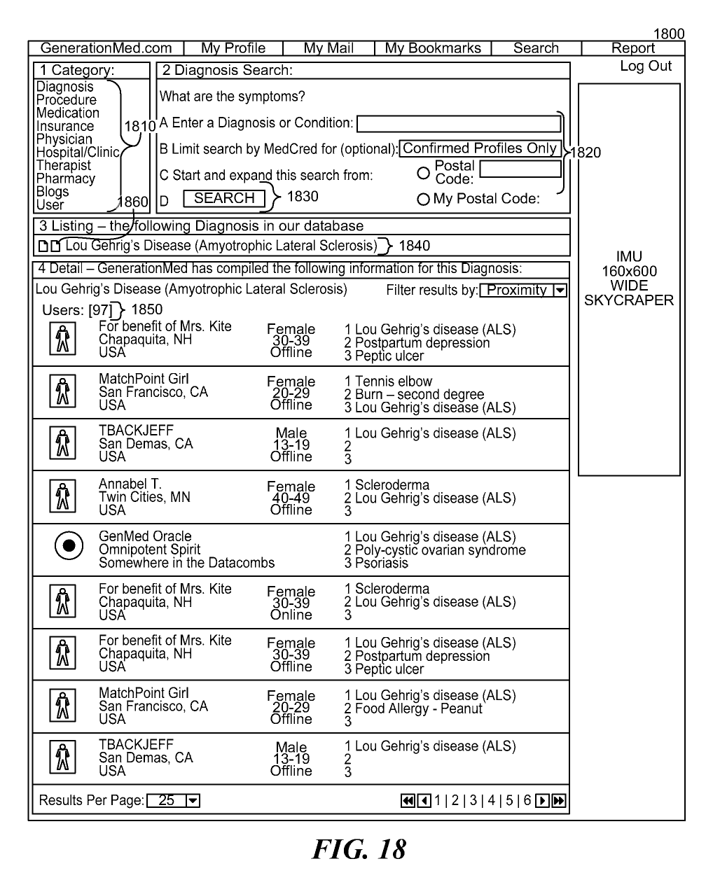

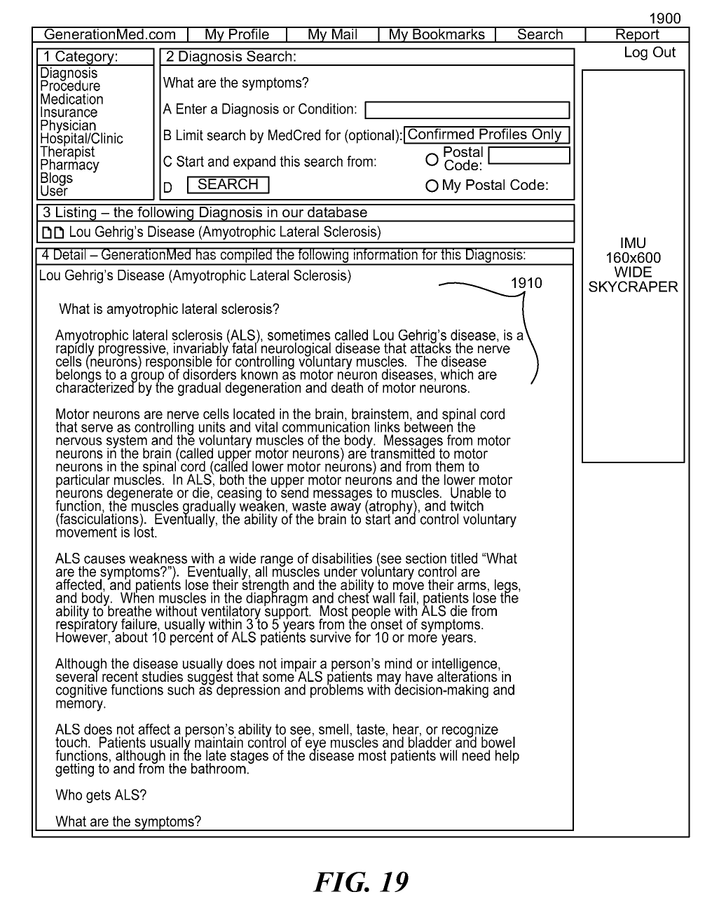

FIG. 18 is a display diagram that illustrates a display page for conducting a search through the medical interaction system in one embodiment. The display page 1800 contains a category selection panel 1810, a search criteria panel 1820, an entity result panel 1840, and a profile result panel 1850. The category selection panel 1810 receives a user selection of the basis for the search, such as by medical entity (e.g., diagnosis, procedure, medication, insurance provider, physician, hospital/clinic, therapist, pharmacy, or blogs) or by user. The search criteria panel 1820 receives search and filter criteria from the user. The search criteria form the basis of the search. For example, search criteria for a diagnosis-based search may include the name or part of the name of a diagnosis. The filter criteria further narrow the search on another basis, such as by the credentials associated with the resulting profiles or the geographic distance from the users associated with the resulting profiles to the searching user. The search criteria panel 1820 contains a search button 1830 that, when activated, initiates the search. The entity result panel 1840 displays a list of entities that match the search criteria. For example, if the search is by diagnosis, then the entity result panel 1840 lists matching medical conditions. When the user selects an entity in the entity result panel 1840, the profile result panel 1850 updates to show the profiles of users associated with the selected entity. The entity result panel 1840 also contains icons 1860 that select whether the system displays the profile results panel 1850 or the entity details panel of FIG. 19. In some embodiments, the system creates a separate entity page that contains the entity result panel 1840 and profile results panel 1850 or the entity details panel of FIG. 19, along with other entity-related information. The separate entity page collects information stored by the system related to the entity and provides a starting point for users to learn more about the entity and connect with other users related to the entity.

FIG. 19 is a display diagram that illustrates an entity details panel displayed after a search in one embodiment. The entity details panel 1910 is displayed when the details icon 1860 is selected as illustrated in FIG. 18. The entity details panel 1910 provides additional information about the selected entity.

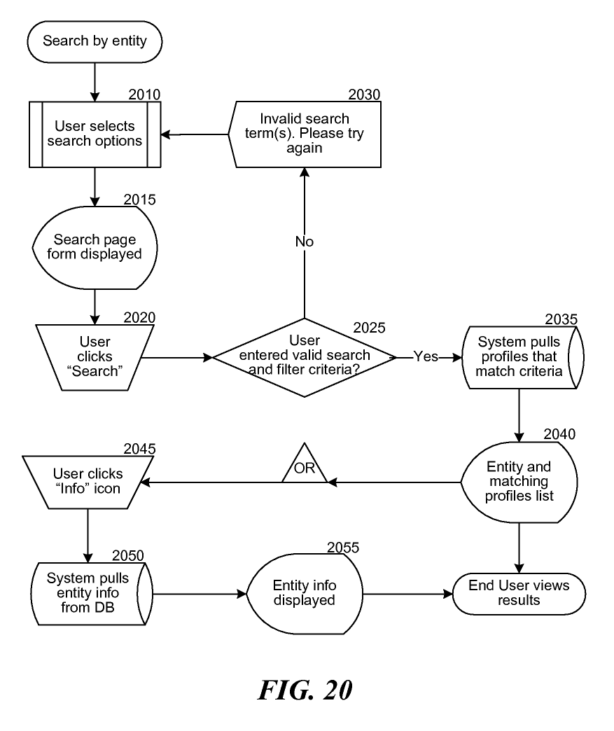

FIG. 20 is a flow diagram that illustrates the processing of the search component of the medical interaction system to identify users based on medical experiences in one embodiment. In block 2010, the component receives a user selection of an entity classification. For example, the user may select to search based on diagnosis, procedure, medication, physician, therapist, hospital/clinic, insurance provider, user, or blog. In block 2015, the component displays the search form for receiving a search criterion that identifies one or more entities. For example, the search criterion may identify an entity name or part of an entity name. The search criterion may also contain wildcards or Boolean operators to expand or narrow the search. The component may also receive one or more filters that narrow the results, such as by geographic proximity of the searching user to the profiles in the results. In block 2020, the component receives an indication that the user activated the search button and executes the search based on the received entity classification and search criterion. For example, the component may query one or more databases containing user profile information to identify matching profiles. In decision block 2025, if there is an error in the received criteria, then the component continues at block 2030 and informs the user of the error, else the component continues at block 2035. After block 2030, the component loops to block 2010 to receive corrected search criteria. In block 2035, the component identifies matching entities and associated profiles based on the received criteria. In block 2040, the component displays the matching entities to the user along with profiles associated with the selected entity (e.g., initially the first entity). If the user selects the details icon, the component continues at block 2045. In block 2050, the component retrieves entity details from a data store of entity information. In block 2055, the component displays the retrieved information to the user. After block 2055, the component completes.

In some embodiments, there are two types of criteria provided by the medical interaction system for searching: search criteria and filter criteria. Search criteria provide fields that are used to match specific pieces of data in a user profiles or elsewhere in the system. Filter criteria provide fields that reduce the number of results returned in response to the search. The following table lists common search and filter criteria for search based on several entity classifications described herein.

| Search classification | Search criteria | Filter criteria |
|---|---|---|
| Search Users | Search Type | Zip Code |
| | Name | City |
| | E-mail Address | Geographical Radius |
| | Keyword | |
| Search Diagnosis | Diagnosis or Condition | Zip Code |
| | | City |
| | | Geographical Radius |
| Search BLOGs | Subject Keywords | BLOG titles only |
| | | BLOG text only |
| | | BLOG text and titles |
| | | City |
| | | Geographical Radius |
| Search Hospitals | Organization Name | Zip Code |
| | Treatment or Specialty | City |
| | | Geographical Radius |
| Search Insurance | Organization Name | Zip Code |
| Companies | | City |
| | | Geographical Radius |
| Search Medications | Medication Name | Zip Code |
| | | City |
| | | Geographical Radius |
| Search Pharmacies | Pharmacy Name | Zip Code |
| | | City |
| | | Geographical Radius |
| Search Physicians | Physician Type | Zip Code |
| | Physician Name | City |
| | | Geographical Radius |
| Search Procedures | Procedure Name | Zip Code |
| | | City |
| | | Geographical Radius |
| Search Therapists | Therapist Type | Zip Code |
| | Therapist Name | City |
| | | Geographical Radius |

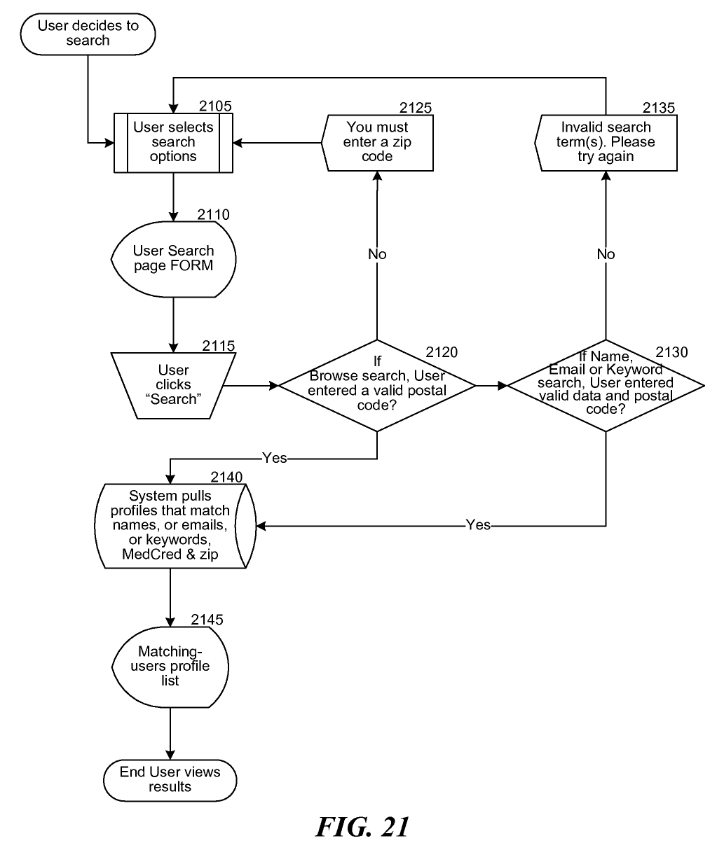

FIG. 21 is a flow diagram that illustrates the processing of the search component of the medical interaction system to conduct a search by user in one embodiment. In block 2105, the component receives search options that indicate that the user wants to search for specific users. In block 2110, the component displays the search form for receiving search criteria. In block 2115, the component receives an indication that the user clicked the search button to initiate the search. In decision block 2120, if the user is browsing and did not enter a valid postal code, then the component continues at block 2125, else the component continues at block 2140. In decision block 2130, if the user is searching by name, email, or keyword and did not enter valid search criteria, then the component continues at block 2135, else the component continues at block 2140. In blocks 2125 and 2135, the component displays an error message to the user and loops to block 2105 to receive new search options. In block 2140, the component identifies matching user profiles based on the received search criteria. In block 2145, the component displays matching profiles to the user. After block 2145, the component completes.

### Credentials

In some embodiments, the medical interaction system verifies the identity and credentials of users. Typical social networks allow users to participate in the network virtually anonymously. In some situations, the experience of users is enhanced by assurance that a user is who he says he is or possesses the credentials that he says he has. For example, a doctor's contributions about a medical condition may be treated as more authoritative than a nurse or layperson's contributions. Thus, the medical interaction system may verify the identity of a user, such as through a credit card, and may verify the credentials of users claiming to hold them. For example, the system may validate a user's name with a state medical licensing board to verify that the user holds a particular medical license. The system may also display a symbol or textual indication in the user's profile to inform other users of the user's identity and credentials. Other users may attribute higher credibility or reputation to a user based on the verified credentials. As described elsewhere herein, users may nevertheless remain anonymous if they choose, such as through mask profiles that hide the user's identity.

In some embodiments, the credentials component receives an indication from a user that the user has received a particular license or other credentials. For example, the indication may include the type of the license, state that granted the license, expiration date of the license, and so forth. The component sends a request to verify the credentials to a trusted information source. For example, the trusted information source may be a web page listing licensed practitioners in a particular state, a database of known practitioners, business listings of practitioners, and so forth. Next, the component receives a response to the verification request. If the response indicates that the credentials were successfully verified, then the component updates the user's profile to indicate that the credentials were successfully verified. When the user's profile is displayed, the profile may contain an icon or other indicator of the user's verified credential status.

In some embodiments, the medical interaction system associates credentials, called achievements, with a user based on one or more criteria. The system may display achievements using special symbols (e.g., an icon) in the MedCred panel of a user's profile. The system awards achievements to users who have accomplished a specific task or milestone within the community. Achievements consist of a title and the specific task achieved. Some example achievements are: a) Legend—a user who has beaten their diagnosis, Energized—a user who achieves 500 Jolts on their Blog, Generator—a user who completes each panel on their profile, Communicator—a user who receives 500 site emails from other users. The system may select the criteria for achievements to reduce the ability of users to abuse the achievement. In general, achievements are selected that are difficult to attain, worthy of attaining, and encourage positive, constructive participation with the system.

### Ratings

In some embodiments, the medical interaction system receives ratings from users of various medical entities, such as medications, treatments, physicians, hospitals, and so on. For example, one type of rating is in the form of a grade as described with respect to gradebooks herein. Another type of rating is a rating of the content of a user's blog. For example, each reader of a user's blog can indicate a positive rating of the blog (called a Jolt) or a negative rating of the blog (called a Tranq). The author of the blog can also classify the blog as a scathing blog (called a Slog) to inform readers that the author intends to rant about a negative experience. Ratings from users may be accumulated into an overall score for a particular medical entity so that users can evaluate the entity based on the opinions of others. In some embodiments, the ratings may be grouped by diagnosis. For example, users may be able to view the overall rating for the drug Aciphex for treating Gastroesophageal Reflux Disease (GERD). Through these ratings, users may form an opinion about the entity based on the individual and collective experiences of others.

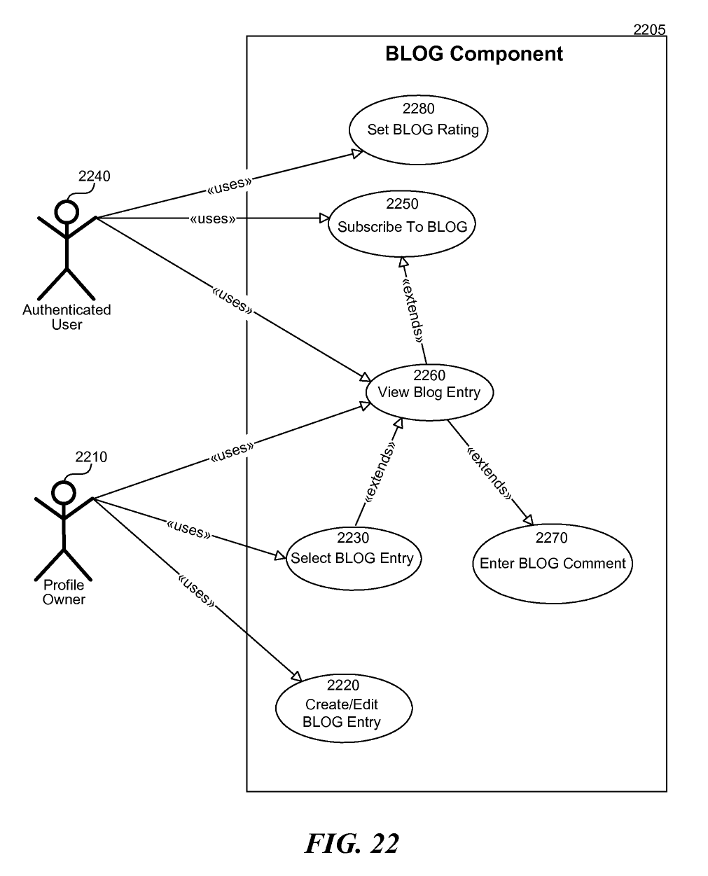

FIG. 22 is a UML diagram that illustrates the functionality of the blog component in one embodiment. The blog component 2205 provides facilities for a profile owner 2210 to create blog entries 2220 and to select 2230 and edit 2220 blog entries. The blog component 2205 also provides facilities for an authenticated user 2240 to subscribe to blogs 2250, view blog entries 2260, comment on blog entries 2270, and rate blogs 2280. Each of these facilities is described in further detail herein.

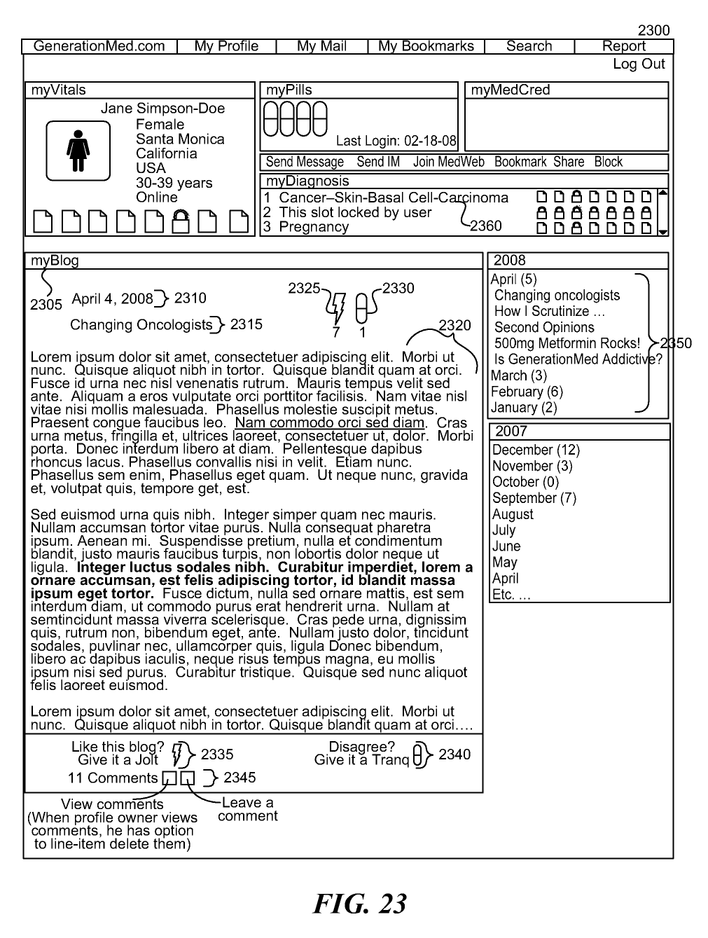

FIG. 23 is a display diagram that illustrates a display page for working with blog entries in one embodiment. The display page 2300 contains a blog panel 2305 that holds one or more blog entries. The blog panel 2305 contains a date 2310, a subject 2315, narrative text 2320, a Jolt indicator 2325, a Tranq indicator 2330, a Jolt control 2335, a Tranq control 2340, and comment controls 2345. The date 2310 indicates the date the profile owner generated the blog entry. The subject 2315 provides an overview of the content of the blog entry. The narrative text 2320 contains whatever content the profile owner wants to convey. The Jolt indicator 2325 displays a count of how many users have enjoyed the blog entry. The Tranq indicator 2330 displays a count of how many users have not enjoyed the blog entry. The Jolt control 2335 allows the user viewing the blog entry to indicate that he/she enjoys the blog entry. The Tranq control 2340 allows the user viewing the blog entry to indicate that he/she does not enjoy the blog entry. For example, the user may disagree with the content of the blog entry or may have had a contrary experience. The comment controls 2345 allow users to view and leave specific comments related to the blog entry. The blog entry may be associated with a currently selected diagnosis 2360. The display page 2300 may also provide controls 2350 for navigating to blog entries based on subject, date, or other criteria.

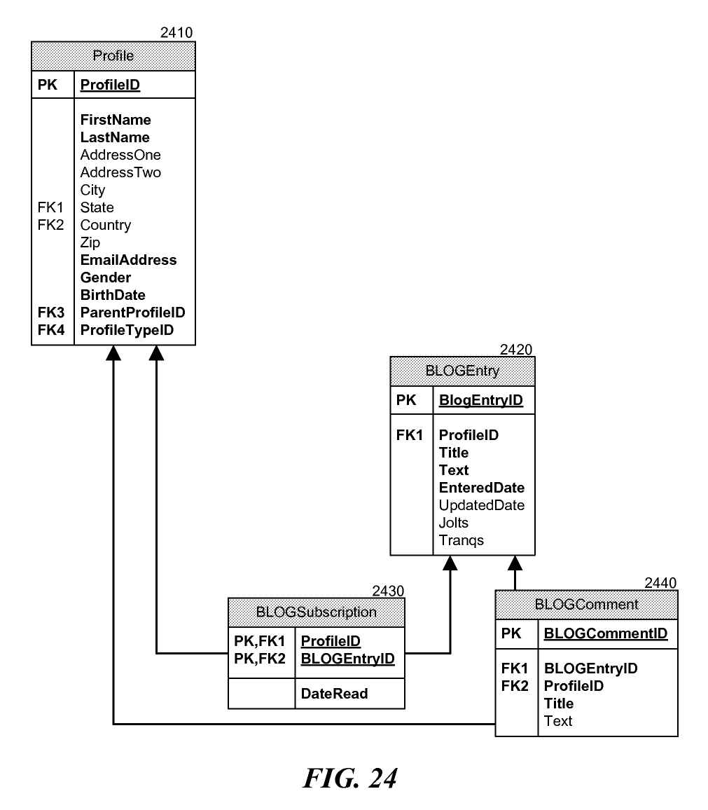

FIG. 24 is a data structure diagram that illustrates the data stored by the blog component in one embodiment. The diagram contains a profile table 2410 that stores user profiles, a blog entry table 2420 that stores blog entries, a blog subscription table 2430 that stores blog subscriptions, and a blog comment table 2440 that stores blog comments. Each blog entry in the blog entry table 2420 is associated with the profile in the profile table 2410 of the user that created the entry. A user can subscribe to a particular blog, such as when the user reads the blog frequently, which causes the blog component to store an entry in the blog subscriptions table 2430. The user can also post comments about blog entries, which are stored in the blog comment table 2440.

### Tiered Access Control

Given the medical nature of content users generate using the medical interaction system, privacy and security is important so that users feel comfortable using the system. Many users of the system will remain anonymous. A valid email address is the only requirement for creating a profile; therefore, users can preserve their anonymity and not worry about submitting any legal identity to the system. The decision to disclose any personal identities within a profile is left to the profile owner. Users may opt, voluntarily, to submit personal information for the sake of receiving credentials or sharing experiences with others in their profiles. If so, the medical interaction system will verify whatever credentials are presented and maintain those records in a data store that is not accessible by other users. The system also generally follows a privacy policy regarding third-party marketing inquiries that includes keeping information private unless required otherwise by Federal or State law. Even though users can remain anonymous, they still desire control over who can access the information stored in their profile.

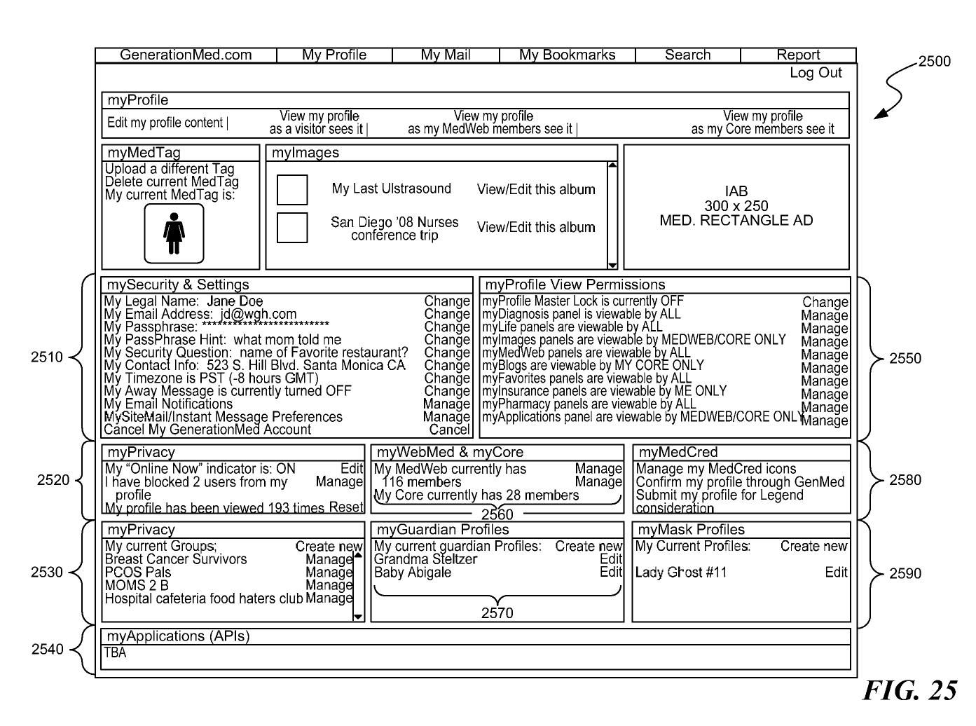

FIG. 25 is a display diagram that illustrates a display page for controlling access to user information in one embodiment. The display page 2500 contains a security and settings panel 2510, a privacy panel 2520, a groups panel 2530, an applications panel 2540, a profile view permissions panel 2550, a MedWeb and Core panel 2560, a guardian profiles panel 2570, a MedCred panel 2580, and a mask profiles panel 2590. The security and settings panel 2510 allows the user to change general settings related to the user's profile, such as the user's email address, password, time zone, and so forth. The privacy panel 2520 allows a user to determine whether other users can tell when a user is online and tracks users blocked from viewing the user's profile. The groups panel 2530 lists groups that the user is a member of and allows the user to manage group memberships. The applications panel 2540 identifies any third party applications that have access to the user's profile. The profile view permissions panel 2550 determines which users can view various information stored in the user's profile. The MedWeb and Core panel 2560 allows a user to manage groups of users that are significant to the user for assigning access rights (described herein). The guardian profiles panel 2570 lists any guardian profiles (described herein) associated with the user. The MedCred panel 2580 lists any credentials obtained by the user and verified by the operator of the medical interaction system. The mask profiles panel 2590 lists any mask profiles (described herein) associated with the user.

In some embodiments, the medical interaction system provides a tiered security model in which the system stores the identity of users that belong to each tier and the user can assign access rights to each tier. For each type of information that a profile owner generates (e.g., the panel pages described herein), the profile owner can specify the access rights of each tier.

The innermost tier is one that includes only the profile owner. This tier is where a profile owner places the most sensitive and private information that the profile owner does not want to share with others. The profile owner may still want to use the information to make connections with others, and the medical interaction system facilitates such connections without exposing this information to others. For example, the system may suggest connections with other users that have a similar diagnosis or are taking a similar medication, without informing the other users of the profile owner's information.

The second tier is called the core. A profile owner's core includes the profile owner and any other user that the profile owner grants entry into the profile owner's core tier. For example, the profile owner might grant his/her doctor or close family member entry into the core tier. The profile owner can designate whether the core can view each type of content associated with the profile owner, and members of the core tier can view any information to which the profile owner grants them access.

The next tier is called the profile owner's MedWeb, and is a circle of close friends of the profile owner. A profile owner's MedWeb may include other users that the profile owner trusts, but does not want to share all information with (else they would be members of the core tier). As users make acquaintances through the medical interaction system, they can add each other to their respective MedWebs to easily monitor one another. MedWebs also provide an important security level for viewing profile content. Within each user's MedWeb is a core, where that user can place their closest or favorite MedWeb members.

The outer-most tier includes all users of the medical interaction system. The profile owner associates information with this tier that should be generally accessible to anyone. This information may include experiences or other information about the user that the user does not consider private and is willing to share with others.

When displaying a profile owner's profile, the medical interaction system determines which panels will be displayed based on the tiers to which the user requesting to view the profile belongs. This may result in different panels being displayed to different users. For example, if the profile owner has only granted the core tier access to the profile owner's blog, then a member of the profile owner's MedWeb may view the myVitals and myLife panels, but not be able to view the profile owner's blog. In some embodiments, tiers are cumulative such that any member of a profile owner's core is also a member of the profile owner's MedWeb.

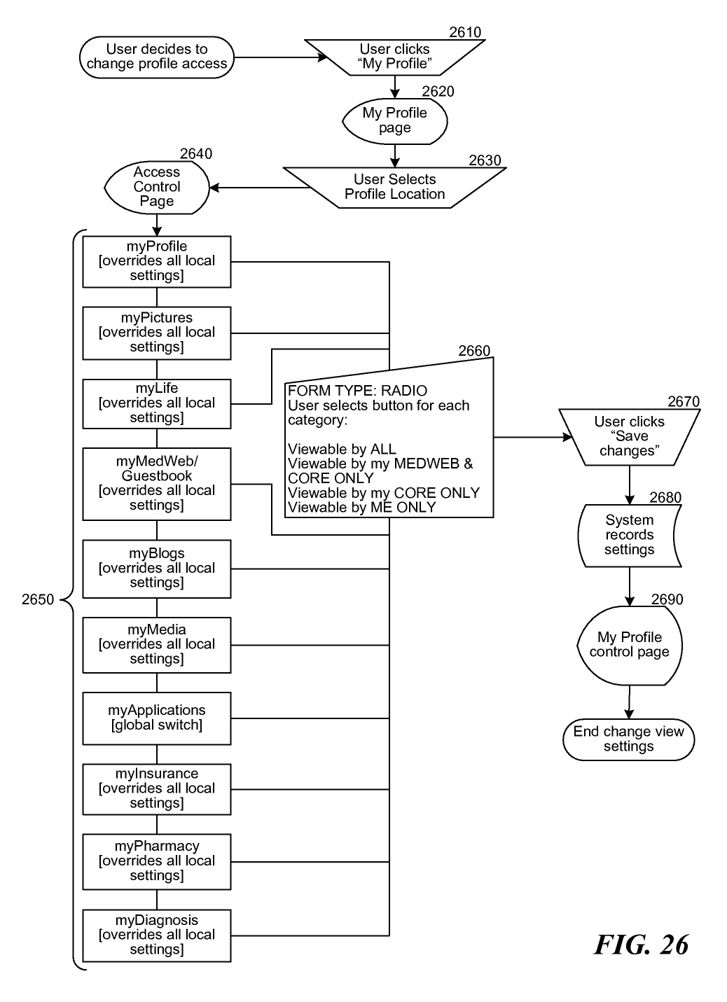

FIG. 26 is a flow diagram that illustrates the processing performed by the access control component to edit profile permissions in one embodiment. In block 2610, the component receives an indication that the user wants to view profile settings. In block 2620, the component displays the profile settings to the user. In block 2630, the component receives a selection of a profile location to edit. In block 2640, the component displays the access control page to the user. In blocks 2650, the user selects a particular category of profile information to edit. In block 2660, the user selects the tiers of users that have access to the category of profile information. For example, the profile owner may grant access to the myLife category of profile information to all users, but restrict access to the myDiagnosis category of profile information to users that are members of the profile owner's MedWeb. In block 2670, the component receives an indication that the user wants to save change made to the access control page. In block 2680, the component stores the modified settings in a data store. In block 2690, the component displays the updated profile control page to the user. After block 2690, the component completes.

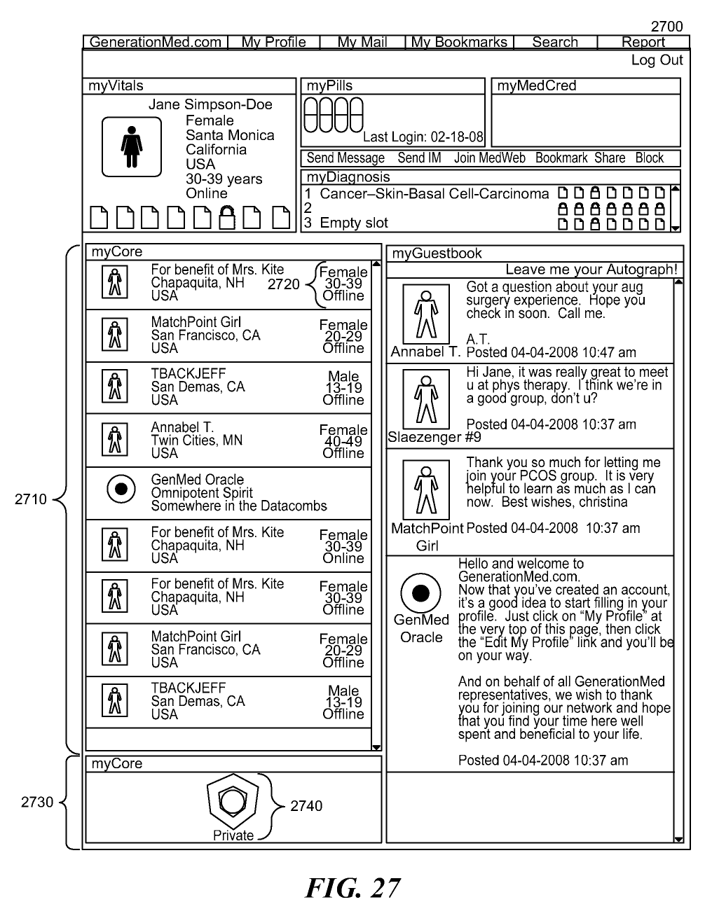

FIG. 27 is a display diagram that illustrates a display page for viewing members of a profile owner's MedWeb in one embodiment. The display page 2700 contains a MedWeb panel 2710 that lists one or more users 2720 that belong to the profile owner's MedWeb. The user entries 2720 contain basic information about the MedWeb member, such as the member's location, age, gender, and online status. The display page 2700 also contains a Core panel 2730 that represents the profile owner's core. The profile owner's core is private, so no members are listed, as indicated by the private icon 2740.

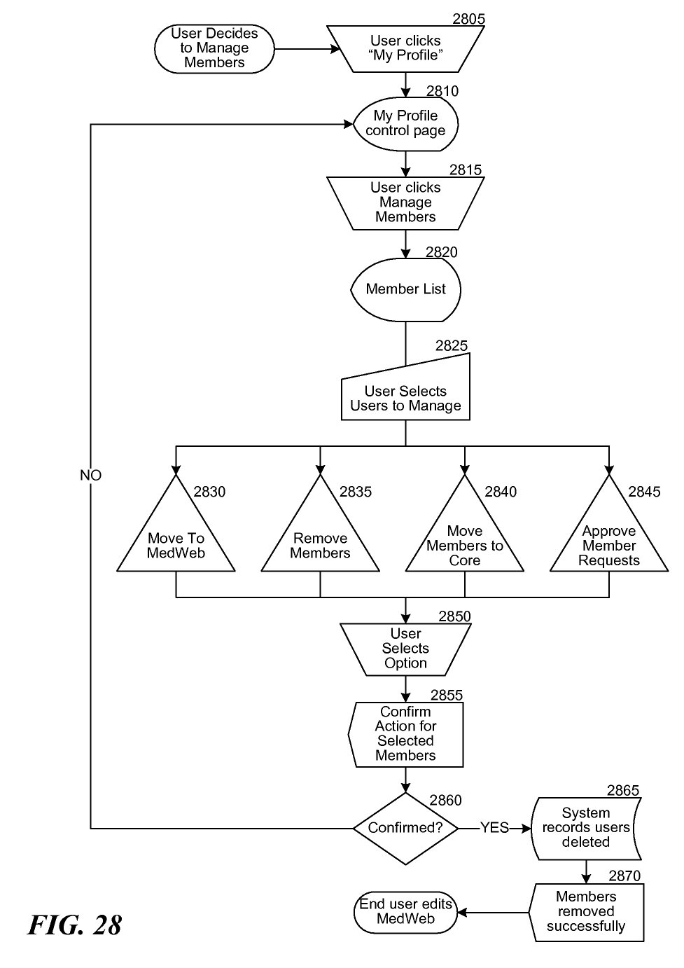

FIG. 28 is a flow diagram that illustrates the processing of the profile management component to modify members of a profile owner's access tiers in one embodiment. In block 2805, the component receives an indication that a profile owner wants to view his/her profile. In block 2810, the component displays the profile control page (e.g., see FIG. 25) to the profile owner. In block 2815, the component receives an indication that the user selected the manage members control. In block 2820, the component displays the list of members of the selected list to the profile owner. In block 2825, the component receives an indication of a user that the profile owner wants to manage. The profile owner can select four types of operations for managing users. In block 2830, the profile owner can select to move a user to the profile owner's MedWeb. In block 2835, the profile owner can select to remove members from the profile owner's MedWeb or Core. In block 2840, the profile owner can select to move members from the profile owner's MedWeb to his/her Core. In block 2845, the profile owner can select to approve requests from users to be added as members of the profile owner's MedWeb or Core. In block 2850, the component receives from the user a selection of an operation to perform. In block 2855, the component requests that the user confirm the selected operation. In decision block 2860, if the user confirms the operation, then the component continues at block 2865, else the component loops to block 2810. In block 2865, the component stores the changes in a data store. In block 2870, the component indicates the success of the operation to the profile owner. After block 2870, the component completes.

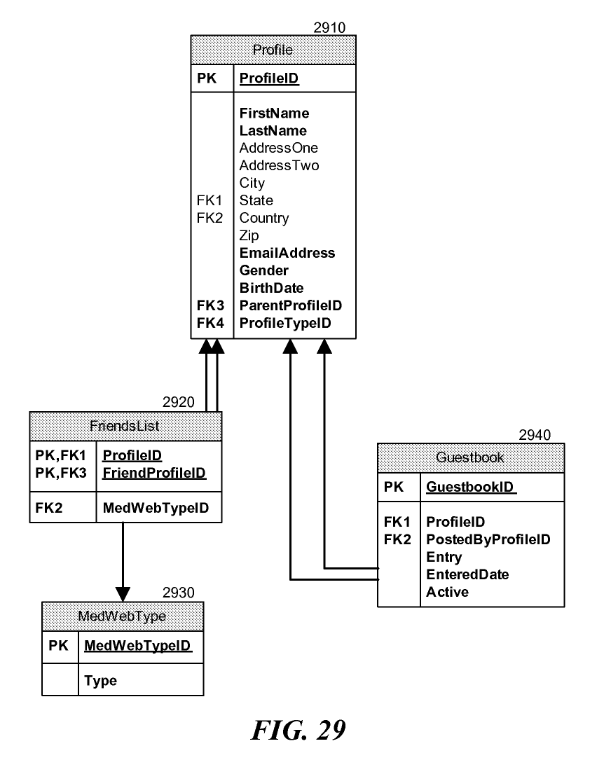

FIG. 29 is a data structure diagram that illustrates the data stored by the medical interaction system for a profile owner's access tiers in one embodiment. The diagram contains a profile table 2910, a friend's list table 2920, a MedWeb type table 2930, and a guestbook 2940. The profile table 2910 stores user profiles. The friends list table 2920 associates users as friends (e.g., MedWeb or Core members) of a profile owner. The MedWeb type table 2930, indicates whether a particular friend is a MedWeb, Core, or other type of member. The guestbook table 2940 stores guestbook entries from other users to the profile owner.

In some embodiments, the medical interaction system represents three classes of users in addition to the tiers described above. These classes of users include unauthenticated users, authenticated users, and administrative users. The system may present a different user interface or different user interface elements to each class of users. Unauthenticated users include any user with a connection to the system, such as a user viewing the public website through the Internet. The system may display a user interface to unauthenticated users that includes news and information about the system in general terms. Information about how to contact a system operator and how to sign up or log in as an authenticated user are also included.

Authenticated users include those users that have signed up for access to the system and have provided at least some information to create a profile. When a user that has a profile logs into the system, the options and information available to him or her changes. For example, an authenticated user's options may change from being informational in nature to functional in nature. Each link will typically send the authenticated user to a page that has functionality.

Administrative users include special users that have the authority to perform administrative functions related to the system. For example, administrative users may be responsible for verifying user credentials, removing offensive users or content from the system, and so on. The medical interaction system may provide a special user interface to administrative users that includes functionality reserved for administrators of the system.

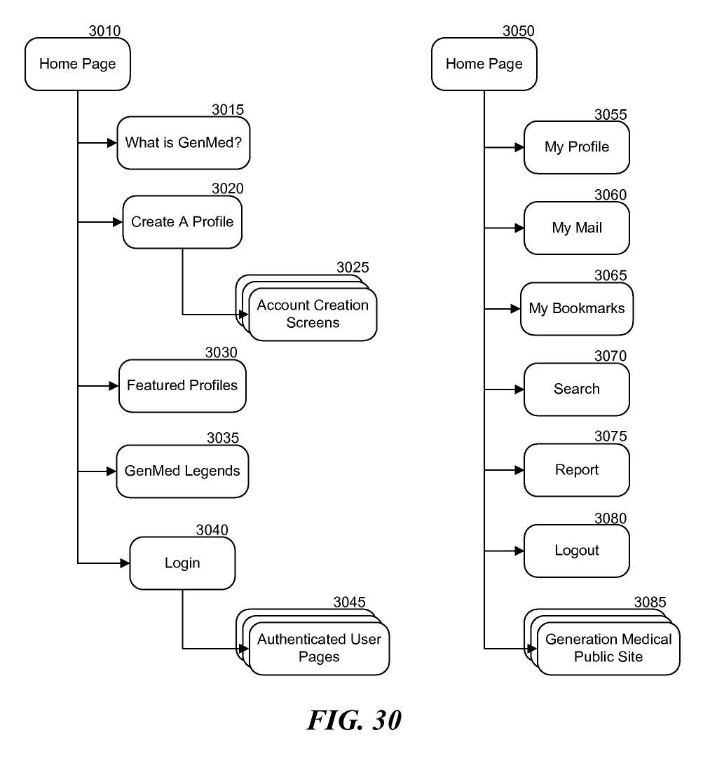

FIG. 30 is a block diagram that illustrates two information hierarchies that the system displays to different user classes in one embodiment. The first hierarchy 3010 illustrates the types of information that are displayed to unauthenticated users, and the second hierarchy 3050 illustrates the types of information that are displayed to authenticated users. Unauthenticated users may view a general information page 3015, a create profile page 3020, features public profiles 3025, legend profiles 3030, and a login page 3035. The general information page 3015 explains the purpose of the medical interaction system to encourage the unauthenticated user to join as a user of the system. The create profile page 3020 allows the unauthenticated user to create a profile and join as a user of the system. The create profile page 3020 leads to one or more account creation pages 3025. The featured public profiles 3030 display select profiles that give the unauthenticated user an idea of the users of the system without compromising private information. The legend profiles 3035 show the unauthenticated users that some users have overcome their diagnosis. The login page 3040 allows the unauthenticated user to enter login information if the unauthenticated user is already a member of the system. The login page 3040 leads to one or more authenticated user pages 3045 as represented by the second hierarchy 3050.

The second hierarchy 3050 displays to an authenticated user a profile page 3055, a mail page 3060, a bookmarks page 3065, a search page 3070, a report page 3075, a logout page 3080, and other general public information pages 3085. The profile page 3055 displays the users stored profile information as described further herein. The mail page 3060 displays email received from other users of the system. The bookmarks page 3065 displays information about other users or medical entities that the authenticated user stored for later viewing. The search page 3070 allows the authenticated user to find other users with similar medical experiences as described herein. The report page 3075 displays reports about items of interest to the authenticated user. The logout page 3080 allows the authenticated user to logout, such as if the user is using a public computer and wants to disconnect from the system. The general public information pages display information available to the public at large, such as those pages in the first hierarchy 3010.

### CONCLUSION

From the foregoing, it will be appreciated that specific embodiments of the medical interaction system have been described herein for purposes of illustration, but that various modifications may be made without deviating from the spirit and scope of the invention. For example, although the system has been described in relation to the medical field, the system could also be applied to other fields where users can connect based on experiences or where members of the field bear certain credentials. As an example, the system could apply to the legal field where users describe particular legal situations in which they participated. As another example, the system could also apply to contractors where users describe projects performed. Accordingly, the invention is not limited except as by the appended claims.

I/We claim:

1. A computer-based method in a social networking system for adding diagnosis-based information to a user profile, the method comprising:
selecting a user profile, wherein the user profile identifies a user of the system and stores information about the identified user;
associating with the selected profile a medical diagnosis received by the user;
receiving diagnosis-based information related to the associated medical diagnosis;
displaying diagnosis-independent information associated with the user profile;
receiving a request to display information about the user related to the associated medical diagnosis; and
displaying the received diagnosis-based information related to the associated medical diagnosis.

2. The method of claim 1 wherein selecting a user profile comprises a second user identifying the user profile through a search based on medical information.

3. The method of claim 1 wherein receiving diagnosis-based information related to the associated medical diagnosis comprises receiving information about a medication taken by the user to treat the associated medical diagnosis.

4. The method of claim 1 wherein receiving diagnosis-based information related to the associated medical diagnosis comprises receiving information about a physician visited by the user to treat the associated medical diagnosis.

5. The method of claim 1 wherein receiving diagnosis-based information related to the associated medical diagnosis comprises receiving information about a procedure received by the user to treat the associated medical diagnosis.

6. The method of claim 1 wherein receiving diagnosis-based information related to the associated medical diagnosis comprises receiving information about an insurance provider used by the user to treat the associated medical diagnosis.

7. The method of claim 1 wherein receiving a request to display information about the user related to the associated medical diagnosis comprises receiving a request to display a chronological log of the user's experience with a medical entity.

8. The method of claim 1 wherein receiving a request to display information about the user related to the associated medical diagnosis comprises receiving a request to display a grade-based log of the user's experience with a medical entity.

9. The method of claim 1 including:
associating with the selected profile a second medical diagnosis received by the user;
receiving diagnosis-based information related to the second associated medical diagnosis;
receiving a request to display information about the user related to the second associated medical diagnosis; and
displaying the received diagnosis-based information related to the second associated medical diagnosis.

10. The method of claim 1 wherein the user profile further comprises information about a person under the care of the user or masked information of a user that wants to hide his/her real identity.

11. A computer system for connecting users of a social network based on shared medical experiences, the system comprising:
a user interface component configured to provide access to the network to multiple users;
a profile store component configured to store information about multiple users and including information about medical experiences of each of the users;
a search component configured to identify users of the social network based on a shared medical experience with a searching user; and
a profile management component configured to establish a connection between the searching user and at least one user identified by the search component based on the shared medical experience.

12. The system of claim 11 including an access control component configured to control access to information stored in a profile by the profile store component based on membership of users in one or more groups specified by an owner of the profile.

13. The system of claim 11 wherein the profile store comprises a legend status for at least one user that indicates that the user has overcome his/her diagnosis.

14. The system of claim 11 including a credentials component configured to store and verify one or more medical credentials associated with a particular user.

15. The system of claim 11 including a blog component configured to store entries from a user in the profile store related to the user's medical experiences.

16. The system of claim 11 wherein the shared medical experience is selected from the group consisting of a diagnosis, procedure, medication, insurance provider, physician, hospital, clinic, therapist, and pharmacy.

17. A computer-readable storage medium encoded with instructions for controlling a computer system to verify medical credentials of a person, by a method comprising:
receiving information from the person indicating that the person holds a specified medical credential;
submitting a request to a trusted authority to determine whether the person holds the specified medical credential;
receiving a response from the trusted authority verifying that the person holds the specified medical credential; and
displaying an indication in association with information about the person that indicates that the person holds a verified medical credential.

18. The computer-readable medium of claim 17 wherein the trusted authority is a state licensing authority and the response verifies that the person holds a license granted by the state licensing authority.

19. The computer-readable medium of claim 17 wherein the displayed indication is a graphical icon that identifies the person as a healthcare professional.

20. The computer-readable medium of claim 17 wherein the medical credential is selected from the group consisting of a physician's license, a registered nurse's license, a physician's assistant's license, a physical therapist's license, and a psychiatrist's license.
